(19) United States
(12) Patent Application Publication
(10) Pub. No.: US 2022/0075613 A1
(43) Pub. Date: Mar. 10, 2022

(54) ADAPTIVE FEEDBACK BASED SYSTEM AND METHOD FOR PREDICTING UPGRADE TIMES AND DETERMINING UPGRADE PLANS IN A VIRTUAL COMPUTING SYSTEM

(71) Applicant: Nutanix, Inc., San Jose, CA (US)

(72) Inventors: Subramanian Ramachandran, Sunnyvale, CA (US); Manoj Sudheendhra, Milpitas, CA (US); Viswanathan Vaidyanathan, Foster City, CA (US); Utkarsh Gupta, Sunnyvale, CA (US)

(73) Assignee: Nutanix, Inc., San Jose, CA (US)

(21) Appl. No.: 17/461,137

(22) Filed: Aug. 30, 2021

Related U.S. Application Data
(60) Provisional application No. 63/075,298, filed on Sep. 7, 2020.

(51) Int. Cl. G06F 8/65; G06F 9/455

(52) U.S. Cl. CPC G06F 8/65; G06F 2009/45595; G06F 9/45558

(57) ABSTRACT

A system and method for updating a cluster of a virtual computing system includes receiving a maintenance window from a user during which to upgrade the cluster, determining available upgrades for the cluster, presenting one or more upgrade plans to the user, such that each of the one or more upgrade plans is created to be completed within the maintenance window and includes one or more of the available upgrades selected based on a total upgrade time computed for each of the available upgrades, receiving selection of one of the one or more upgrade plans from the user, and upgrading the cluster based on the one of the one or more upgrade plans that is selected.

### CROSS-REFERENCE TO RELATED APPLICATIONS

This is a non-provisional of U.S. provisional application No. 63/075,298, filed on Sep. 7, 2020, the entirety of which is incorporated by reference herein.

### BACKGROUND

Virtual computing systems are widely used in a variety of applications. Virtual computing systems include one or more host machines running one or more virtual machines concurrently. The virtual machines utilize the hardware resources of the underlying host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, the present-day virtual computing systems have limitations due to their configuration and the way they operate.

### SUMMARY

In accordance with some aspects of the present disclosure, a method is disclosed. The method includes receiving, by a life cycle manager in a virtual computing system, a maintenance window from a user during which to upgrade a cluster of the virtual computing system, determining, by the life cycle manager, available upgrades for the cluster, presenting, by the life cycle manager, one or more upgrade plans to the user, such that each of the one or more upgrade plans is created to be completed within the maintenance window and includes one or more of the available upgrades selected based on a total upgrade time computed for each of the available upgrades, receiving, by the life cycle manager, selection of one of the one or more upgrade plans from the user, and upgrading, by the life cycle manager, the cluster based on the one of the one or more upgrade plans that is selected.

In accordance with some other aspects of the present disclosure, a non-transitory computer-readable media having computer-readable instructions stored thereon is disclosed. The computer-readable instructions when executed by a processor of a lifecycle manager associated with a virtual computing system cause the processor to perform a process including receiving a maintenance window from a user during which to upgrade a cluster of the virtual computing system, determining available upgrades for the cluster, presenting one or more upgrade plans to the user, such that each of the one or more upgrade plans is created to be completed within the maintenance window and includes one or more of the available upgrades selected based on a total upgrade time computed for each of the available upgrades, receiving selection of one of the one or more upgrade plans from the user, and upgrading the cluster based on the one of the one or more upgrade plans that is selected.

In accordance with yet other aspects of the present disclosure, a system is disclosed. The system includes a memory of a lifecycle manager in a virtual computing system, the memory storing computer-readable instructions and a processor executing the computer-readable instructions to receive a maintenance window from a user during which to upgrade a cluster of the virtual computing system, determine available upgrades for the cluster, present one or more upgrade plans to the user, such that each of the one or more upgrade plans is created to be completed within the maintenance window and includes one or more of the available upgrades selected based on a total upgrade time computed for each of the available upgrades, receive selection of one of the one or more upgrade plans from the user, and upgrade the cluster based on the one of the one or more upgrade plans that is selected.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is an example block diagram of a cluster of a virtual computing system in a hyperconverged system, in accordance with some embodiments of the present disclosure.

FIG. 2 is an example block diagram of an update system for updating components of the virtual computing system of FIG. 1, in accordance with some embodiments of the present disclosure.

FIG. 3 is an example block diagram of a life cycle manager of the update system of FIG. 2, in accordance with some embodiments of the present disclosure.

FIG. 4 is an example flowchart outlining operations for a planning assistance feature of the life cycle manager of FIG. 3, in accordance with some embodiments of the present disclosure.

FIG. 5 is an example flow diagram showing the planning assistance feature of FIG. 4 in greater detail, in accordance with some embodiments of the present disclosure.

FIG. 6 is another example flowchart outlining additional operations of the planning assistance feature of FIG. 4, in accordance with some embodiments of the present disclosure.

FIGS. 7A-7D are example screenshots showing the planning assistance feature of FIGS. 4-6, in accordance with some embodiments of the present disclosure.

FIGS. 8A and 8B are example flowcharts outlining operations for executing an upgrade operation using the life cycle manager of FIG. 3, in accordance with some embodiments of the present disclosure.

FIGS. 9A-9G show screenshots of an execution assistance feature of the life cycle manager of FIG. 3, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to performing updates of a component (e.g., cluster) in a virtual computing system having a plurality of clusters, with each cluster having one or more host machines or nodes. Each node may include one or more virtual machines, with each virtual machine being managed, controlled, and otherwise operated by an instance of a virtual machine monitor (e.g., hypervisor) and a controller/service virtual machine (CVM). Proper operation of the various components (e.g., host machines, virtual machines, network devices, storage devices, etc., also collectively referred to herein as “entities”) of the virtual computing system may require periodically upgrading those components to provide new features, security fixes, enhance user experience, etc. Updates to a component may involve software updates, hardware updates, and/or firmware updates. For example, updates may include operating system updates, virtual machine monitor upgrades, or upgrades to other software associated with the various components of the virtual computing system. The terms “update” and “upgrade” are used interchangeably herein.

To perform an upgrade on a component, that component may be placed in a maintenance mode and booted into a specific update “environment” or “state.” The upgrade may be performed in that update environment, and upon finishing the upgrade, the component may be booted out of that update environment and removed from maintenance mode. An “update environment” or “update state” may include various libraries, scripts, binaries, and/or other types of data, including an ISO file image, that may enable updating a component. Example update environments or states may include Phoenix, IVU (In Virtual Machine Updates), etc. Thus, a component of the virtual computing system may be running in a Phoenix environment, an IVU environment, etc. during updates. In some embodiments, to perform an upgrade, a Life Cycle Manager (LCM) may be used. LCM may allow for lifecycle management of firmware and software entities within a virtual computing system (e.g., a distributed datacenter) without disruption by intelligently managing upgrades through comprehensive dependency management and one-click simplicity.

In some embodiments, the LCM may perform updates in one or more phases. For example, in a first phase, the LCM may perform steps to prepare the environment before the actual upgrade. For example, before the upgrade to a new version the LCM may check for compatibility of a component to ensure that the component is able to upgrade from the existing version and remain operational after the upgrade. The LCM may also check for network connectivity, amount of space needed for the update, amount of space available on the cluster, etc.

Upon completing the first phase, the LCM may install the upgrade to the component. In some embodiments, the upgrade may be applied to one node at a time to ensure continuity of operation such that the other nodes continue to operate while one node is being upgraded. The node being upgraded may be allocated an upgrade token. Before the upgrade, virtual machines from the node holding the upgrade token may be migrated out and any input/output requests to the migrated virtual machines may be forwarded to the nodes to which the virtual machines are migrated to. Any virtual machines that are unable to migrate out may be shut down. Upon migrating the virtual machines or shutting down the virtual machines, the node may be upgraded. In some embodiments, the node may be rebooted into a desired upgrade environment (e.g., Phoenix) before the update. When the upgrade is complete, the node is rebooted to implement the update and to move out of the update environment and into the operating environment. The virtual machines may then be migrated back to the node and the virtual machines that were shut down may be restarted to complete the update. When the update is complete, the upgrade token may be released and allocated to a next node that needs to be updated. Thus, an LCM upgrade may include the following stages: (1) checking for system conditions that may fail the upgrade (pre-check), (2) downloading of artifacts needed for the upgrade, (3) performing the upgrade operation (this stage may itself include multiple stages), and (4) running compatibility checks after a successful upgrade.

In some embodiments, the above process of updating a component is time consuming. For example, in some embodiments, the total time for upgrading each node may be around 20-50 minutes. Further, the above process requires migrating out virtual machines or shutting down virtual machines, and rebooting the node, which may all disrupt operations and cause inconvenience to a user. In some embodiments, updates in the IVU environment (e.g., IVU updates) may be more desirable. Updates in the IVU environment may avoid the need for migrating or shutting down the virtual machines, as well as possibly avoid the need for rebooting the node upon completing the update. IVU updates may be particularly beneficial for firmware updates (e.g., disk upgrades) or any component that is “passed through” to the CVM. A component may be “passed through” to the CVM if that component is owned by or otherwise managed by the CVM. IVU updates may be performed in the CVM itself, as opposed to the node. In some embodiments, a reboot of the CVM may be needed to implement the update. However, a reboot of the node may still be avoided. IVU updates may be much faster than Phoenix updates. For example, in some embodiments, an IVU update may take a total time (e.g., of all the nodes included) of about 10-30 minutes, with about 1-2 minutes for rebooting to and out of IVU. In other embodiments, other types of update environments or update states may be used.

While the LCM provides a simple and convenient (e.g., 1-click) mechanism for updating firmware and software in a distributed virtual computing system (e.g., a hyperconverged system), the LCM is unable to predict upgrade times and plan an upgrade for a user. Specifically, the amount of time a particular upgrade may take to complete may vary depending upon a variety of factors. For example, depending upon the type of upgrade (e.g., software vs. firmware, etc.) to be performed, the number of updates being applied, the size of the cluster on which the upgrade is to be performed, the time needed for the performing the first phase operations discussed above, etc., the amount of time taken for an upgrade may vary regardless of the type of update environment that the LCM uses. Without the ability to accurately predict upgrade times, a user may be unable to plan a maintenance window.

In some embodiments, internal policies may dictate when an upgrade operation may be performed. For example, in some cases, upgrades may be performed at predetermined times of the day to minimize outages or reduce impact of outages. These predetermined times may be considered a “maintenance window.” Thus, a maintenance window may be considered a period of time, usually but not always, during non-busy hours (e.g., at night), during which a cluster may be upgraded. For example, if a maintenance window is designated as 3 hours, but the total time needed to perform all the updates exceeds 3 hours, not all the updates may be applied. In some embodiments, the user may not know until after the maintenance window has passed which updates were applied, and which failed (or could not be applied due to the maintenance window running out). In some cases, updates that did not complete may be more critical updates. To allow for all updates to be applied, in some cases, the user may plan for a much longer maintenance window. However, the longer maintenance window may impact the normal operation of the cluster and may generally be undesirable. This inability to accurately plan a maintenance window leads to uncertainty and may possibly lead to postponing critical updates to avoid disruptions. Thus, despite the LCM performing upgrades in a simply, non-disruptive fashion, the uncertainty of planning these upgrades may lead to undesirable outcomes.

Thus, the present disclosure provides technical solutions for accurately predicting update times, as well as enabling a user to accurately plan a maintenance window. Specifically, the present disclosure provides an LCM that is configured to estimate an upgrade time for each type of upgrade that may be applied to a cluster and plan a user's maintenance window, including recommending an upgrade plan to a user based on user defined preferences or parameters. In some embodiments, the LCM provides a planning assistance feature and an execution assistance feature. The planning assistance feature provides assistance to accurately estimate upgrade times, plan upgrades within a user's desired maintenance window, and recommend one or more upgrade plans to the user to suit user's preferences. The execution assistance feature of the LCM effectively executes an upgrade plan by allowing users to pause upgrade, auto-pausing upgrades when problems are detected, diagnosing errors during the upgrade, recommending and/or performing recovery actions to resolve the errors, and resuming upgrade from where the upgrade was paused, thereby increasing the likelihood that upgrades complete even when errors are detected during the upgrade process. The planning assistance feature and the execution assistance feature may together form an update assistance feature.

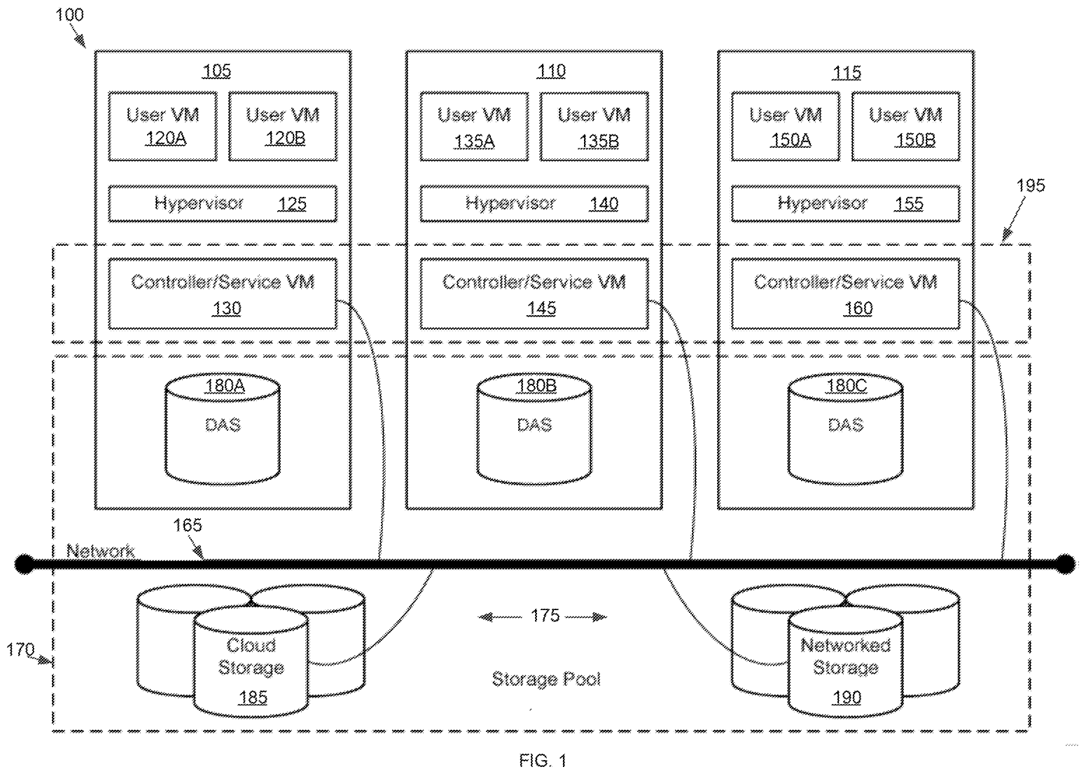

Referring now to FIG. 1, a hyperconverged cluster 100 of a virtual computing system is shown, in accordance with some embodiments of the present disclosure. The cluster 100 may be hosted on-premise or may be located on a cloud. The cluster 100 includes a plurality of nodes, such as a first node 105, a second node 110, and a third node 115. Each of the first node 105, the second node 110, and the third node 115 may also be referred to as a “host” or “host machine.” The first node 105 includes user virtual machines (“user VMs”) 120A and 120B (collectively referred to herein as “user VMs 120”), a hypervisor 125 configured to create and run the user VMs, and a controller/service virtual machine (CVM) 130 configured to manage, route, and otherwise handle workflow requests between the various nodes of the cluster 100. Similarly, the second node 110 includes user VMs 135A and 135B (collectively referred to herein as “user VMs 135”), a hypervisor 140, and a CVM 145, and the third node 115 includes user VMs 150A and 150B (collectively referred to herein as “user VMs 150”), a hypervisor 155, and a CVM 160. The CVM 130, the CVM 145, and the CVM 160 are all connected to a network 165 to facilitate communication between the first node 105, the second node 110, and the third node 115. Although not shown, in some embodiments, the hypervisor 125, the hypervisor 140, and the hypervisor 155 may also be connected to the network 165.

The cluster 100 also includes and/or is associated with a storage pool 170. The storage pool 170 may include network-attached storage 175 and direct-attached storage 180A, 180B, and 180C. The network-attached storage 175 is accessible via the network 165 and, in some embodiments, may include cloud storage 185, as well as local storage area network 190. In contrast to the network-attached storage 175, which is accessible via the network 165, the direct-attached storage 180A, 180B, and 180C includes storage components that are provided internally within each of the first node 105, the second node 110, and the third node 115, respectively, such that each of the first, second, and third nodes may access its respective direct-attached storage without having to access the network 165.

It is to be understood that only certain components of the cluster 100 are shown in FIG. 1. Nevertheless, several other components that are needed or desired in the cluster 100 to perform the functions described herein are contemplated and considered within the scope of the present disclosure.

Although three of the plurality of nodes (e.g., the first node 105, the second node 110, and the third node 115) are shown in the cluster 100, in other embodiments, greater than or fewer than three nodes may be used. Likewise, although only two of the user VMs (e.g., the user VMs 120, the user VMs 135, and the user VMs 150) are shown on each of the respective first node 105, the second node 110, and the third node 115, in other embodiments, the number of the user VMs on each of the first, second, and third nodes may vary to include either a single user VM or more than two user VMs. Further, the first node 105, the second node 110, and the third node 115 need not always have the same number of the user VMs (e.g., the user VMs 120, the user VMs 135, and the user VMs 150).

In some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In some embodiments, one or more of the first node 105, the second node 110, and the third node 115 may include bare metal instances (e.g., Amazon Web Services bare metal instances) in cloud. In other embodiments, one or more of the first node 105, the second node 110, or the third node 115 may be another type of hardware device, such as a personal computer, an input/output or peripheral unit such as a printer, or any type of device that is suitable for use as a node within the cluster 100. In some embodiments, the cluster 100 may be part of a data center.

Each of the first node 105, the second node 110, and the third node 115 may also be configured to communicate and share resources with each other via the network 165. For example, in some embodiments, the first node 105, the second node 110, and the third node 115 may communicate and share resources with each other via the CVM 130, the CVM 145, and the CVM 160, and/or the hypervisor 125, the hypervisor 140, and the hypervisor 155. One or more of the first node 105, the second node 110, and the third node 115 may be organized in a variety of network topologies.

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 170, as well as with other elements of the first node 105, the second node 110, and the third node 115 to receive, send, and process information, and to control the operations of the underlying first, second, or third node. The processing units may retrieve a set of instructions from the storage pool 170, such as, from a permanent memory device like a read only memory (“ROM”) device and copy the instructions in an executable form to a temporary memory device that is generally some form of random access memory (“RAM”). The ROM and RAM may both be part of the storage pool 170, or in some embodiments, may be separately provisioned from the storage pool. Further, the processing units may include a single stand-alone processing unit, or a plurality of processing units that use the same or different processing technology.

With respect to the storage pool 170 and particularly with respect to the direct-attached storage 180A, 180B, and 180C, each of the direct-attached storage may include a variety of types of memory devices. For example, in some embodiments, one or more of the direct-attached storage 180A, 180B, and 180C may include, but is not limited to, any type of RAM, ROM, flash memory, magnetic storage devices (e.g., hard disk, floppy disk, magnetic strips, etc.), optical disks (e.g., compact disk (“CD”), digital versatile disk (“DVD”), etc.), smart cards, solid state devices, etc. Likewise, the network-attached storage 175 may include any of a variety of network accessible storage (e.g., the cloud storage 185, the local storage area network 190, etc.) that is suitable for use within the cluster 100 and accessible via the network 165. The storage pool 170, including the network-attached storage 175 and the direct-attached storage 180A, 180B, and 180C, together form a distributed storage system configured to be accessed by each of the first node 105, the second node 110, and the third node 115 via the network 165, the CVM 130, the CVM 145, the CVM 160, and/or the hypervisor 125, the hypervisor 140, and the hypervisor 155. In some embodiments, the various storage components in the storage pool 170 may be configured as virtual disks for access by the user VMs 120, the user VMs 135, and the user VMs 150.

Each of the user VMs 120, the user VMs 135, and the user VMs 150 is a software-based implementation of a computing machine. The user VMs 120, the user VMs 135, and the user VMs 150 emulate the functionality of a physical computer. Specifically, the hardware resources, such as processing unit, memory, storage, etc., of the underlying computer (e.g., the first node 105, the second node 110, and the third node 115) are virtualized or transformed by the respective hypervisor 125, the hypervisor 140, and the hypervisor 155, into the underlying support for each of the user VMs 120, the user VMs 135, and the user VMs 150 that may run its own operating system and applications on the underlying physical resources just like a real computer. By encapsulating an entire machine, including CPU, memory, operating system, storage devices, and network devices, the user VMs 120, the user VMs 135, and the user VMs 150 are compatible with most standard operating systems (e.g. Windows, Linux, etc.), applications, and device drivers. Thus, each of the hypervisor 125, the hypervisor 140, and the hypervisor 155 is a virtual machine monitor that allows a single physical server computer (e.g., the first node 105, the second node 110, third node 115) to run multiple instances of the user VMs 120, the user VMs 135, and the user VMs 150, with each user VM sharing the resources of that one physical server computer, potentially across multiple environments. For example, each of the hypervisor 125, the hypervisor 140, and the hypervisor 155 may allocate memory and other resources to the underlying user VMs (e.g., the user VMs 120, the user VMs 135, and the user VMs 150) from the storage pool 170 to perform one or more functions.

By running the user VMs 120, the user VMs 135, and the user VMs 150 on each of the first node 105, the second node 110, and the third node 115, respectively, multiple workloads and multiple operating systems may be run on a single piece of underlying hardware computer (e.g., the first node, the second node, and the third node) to increase resource utilization and manage workflow. When new user VMs are created (e.g., installed) on the first node 105, the second node 110, and the third node 115, each of the new user VMs may be configured to be associated with certain hardware resources, software resources, storage resources, and other resources within the cluster 100 to allow those virtual VMs to operate as intended.

The user VMs 120, the user VMs 135, the user VMs 150, and any newly created instances of the user VMs are controlled and managed by their respective instance of the CVM 130, the CVM 145, and the CVM 160. The CVM 130, the CVM 145, and the CVM 160 are configured to communicate with each other via the network 165 to form a distributed system 195. Each of the CVM 130, the CVM 145, and the CVM 160 may be considered a local management system configured to manage various tasks and operations within the cluster 100. For example, in some embodiments, the local management system may perform various management related tasks on the user VMs 120, the user VMs 135, and the user VMs 150.

The hypervisor 125, the hypervisor 140, and the hypervisor 155 of the first node 105, the second node 110, and the third node 115, respectively, may be configured to run virtualization software, such as, ESXi from VMWare, AHV from Nutanix, Inc., XenServer from Citrix Systems, Inc., etc. The virtualization software on the hypervisor 125, the hypervisor 140, and the hypervisor 155 may be configured for running the user VMs 120, the user VMs 135, and the user VMs 150, respectively, and for managing the interactions between those user VMs and the underlying hardware of the first node 105, the second node 110, and the third node 115. Each of the CVM 130, the CVM 145, the CVM 160, the hypervisor 125, the hypervisor 140, and the hypervisor 155 may be configured as suitable for use within the cluster 100.

The network 165 may include any of a variety of wired or wireless network channels that may be suitable for use within the cluster 100. For example, in some embodiments, the network 165 may include wired connections, such as an Ethernet connection, one or more twisted pair wires, coaxial cables, fiber optic cables, etc. In other embodiments, the network 165 may include wireless connections, such as microwaves, infrared waves, radio waves, spread spectrum technologies, satellites, etc. The network 165 may also be configured to communicate with another device using cellular networks, local area networks, wide area networks, the Internet, etc. In some embodiments, the network 165 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the cluster 100. For example, a particular user VM (e.g., the user VMs 120, the user VMs 135, or the user VMs 150) may direct an input/output request to the CVM (e.g., the CVM 130, the CVM 145, or the CVM 160, respectively) on the underlying node (e.g., the first node 105, the second node 110, or the third node 115, respectively). Upon receiving the input/output request, that CVM may direct the input/output request to the CVM (e.g., one of the CVM 130, the CVM 145, or the CVM 160) of the leader node. In some cases, the CVM that receives the input/output request may itself be on the leader node, in which case, the CVM does not transfer the request, but rather handles the request itself.

The CVM of the leader node may fulfil the input/output request (and/or request another component within/outside the cluster 100 to fulfil that request). Upon fulfilling the input/output request, the CVM of the leader node may send a response back to the CVM of the node from which the request was received, which in turn may pass the response to the user VM that initiated the request. In a similar manner, the leader node may also be configured to receive and handle requests (e.g., user requests) from outside of the cluster 100. If the leader node fails, another leader node may be designated.

Additionally, in some embodiments, although not shown, the cluster 100 is associated with a central management system that is configured to manage and control the operation of multiple clusters in the virtual computing system. In some embodiments, the central management system may be configured to communicate with the local management systems on each of the CVM 130, the CVM 145, the CVM 160 for controlling the various clusters.

Again, it is to be understood again that only certain components and features of the cluster 100 are shown and described herein. Nevertheless, other components and features that may be needed or desired to perform the functions described herein are contemplated and considered within the scope of the present disclosure. It is also to be understood that the configuration of the various components of the cluster 100 described above is only an example and is not intended to be limiting in any way. Rather, the configuration of those components may vary to perform the functions described herein.

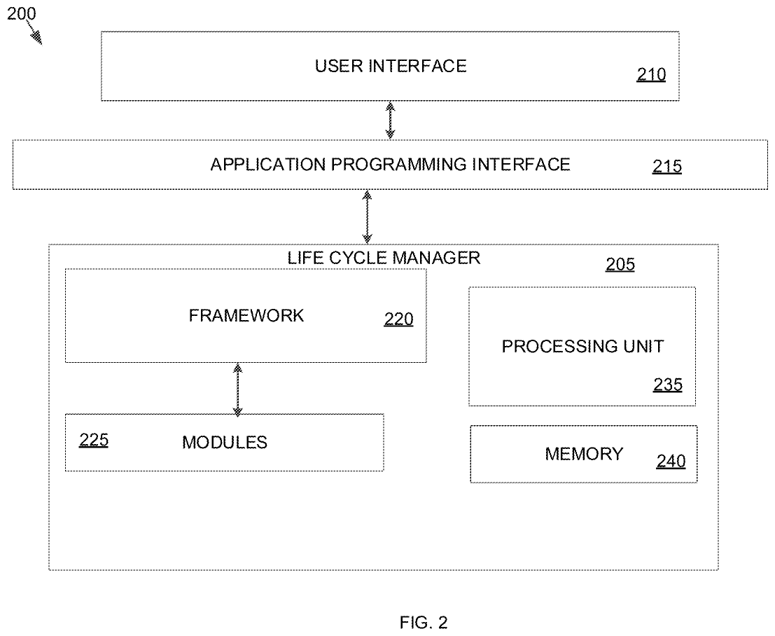

Referring now to FIG. 2, an example block diagram of an update system 200 is shown, in accordance with some embodiments of the present disclosure. The update system 200 may be configured to upgrade components of the cluster 100. For example, the update system 200 may be configured to provide software and firmware upgrades. In some embodiments, the software and/or firmware upgrades may be one-click upgrades (e.g., a single click may start the update process). The update system 200 includes a Life Cycle Manager (LCM) 205 that tracks software and firmware versions of one or more entities in the cluster 100. In some embodiments, the LCM 205 may be configured to track software and firmware versions across a single cluster, while in other embodiments, the LCM may be configured to track the software and firmware versions across multiple clusters. Based on the tracking, the LCM 205 may decide, in some embodiments, whether a particular component is to be updated, and if so, the LCM may decide when to update that component. In other embodiments, the LCM 205 may receive an indication (e.g., user input) to update a component, and in response to receiving that indication, the LCM may update that component. In some embodiments, the LCM 205 may be configured to perform the software and firmware updates of components or entities in a single cluster, while in other embodiments, the LCM may be configured to perform software and firmware updates across multiple clusters.

In some embodiments, the LCM 205 may be installed on the leader CVM (e.g., the CVM 130, the CVM 145, or the CVM 160) of a cluster. In other embodiments, the LCM 205 may be installed on one or more other designated CVM(s) (e.g., the CVM 130, the CVM 145, or the CVM 160, respectively). In some embodiments, the LCM 205 may be configured as a software service. In other embodiments, the LCM 205 may be configured as any combination of software, hardware, and/or firmware. In some embodiments, the LCM 205 may provide a one-click upgrade simplicity, automatic dependency management, unified upgrade process that provides multi hypervisor and multi hardware flexibility, while self managing itself.

The LCM 205 may be configured to communicate with a user through a user interface 210 via an application programming interface (“API”) 215. In some embodiments, a user may provide inputs to the LCM 205 for requesting/planning updates to an entity of the cluster 100, as well as to receive outputs from the LCM. In some embodiments, the user interface 210 may be accessed through or be a part of a management system or controller that manages/controls all of the nodes (e.g., the first node 105, the second node 110, or the third node 115) of a single cluster. In other embodiments, the user interface 210 may be part of a management system or controller that manages/controls multiples clusters.

The LCM 205 may form the backend of the update system 200, while the user interface 210 may form the front-end of the update system. The user may, via the user interface 210, instruct the LCM 205 to perform one or more operations. Upon receiving instructions from the user interface 210, the LCM 205 may perform actions consistent with those instructions. Thus, the LCM 205 is not visible to the user but is rather configured to operate under control of inputs received via the user interface 210, which is visible to and operated by the user. In some embodiments, the LCM 205 may be configured to perform certain operations autonomously without requiring any user input.

In some embodiments, the user interface 210 may be installed on a device associated with the management system described above. In other embodiments, instead of or in addition to being installed on a particular device, the user interface 210 may be hosted on a cloud service and may be accessed via the cloud. In some embodiments, the user interface 210 may additionally or alternatively be configured as a mobile application that is suitable for installing on and access from a mobile computing device (e.g., a mobile phone). Thus, the user interface 210 may be installed in a variety of ways.

Further, the user interface 210 may be configured to access the LCM 205 in a variety of ways. For example, in some embodiments, the user interface 210 may be configured to access the LCM 205 via the API 215. To access the LCM 205 via the API 215, users may access the user interface 210 via designated devices such as laptops, desktops, tablets, mobile devices, other handheld or portable devices, and/or other types of computing devices that are configured to access the API. These devices may be different from the device on which the LCM 205 is installed.

In some embodiments and when the user interface 210 is configured for use via the API 215, the users may access the LCM 205 via a web browser and upon entering a uniform resource locator (“URL”) for the API. Using the API 215, the users may then send instructions to the LCM 205 and receive information back from the policy engine. In some embodiments, the API 215 may be a representational state transfer (“REST”) type of API. In other embodiments, the API 215 may be any other type of web or other type of API (e.g., ASP.NET) built using any of a variety of technologies, such as Java, .NET, etc., that is capable of accessing the LCM 205 and facilitating communication between the users and the policy engine.

In some embodiments, the API 215 may be configured to facilitate communication between the users via the user interface 210 and the LCM 205 via a hypertext transfer protocol (“HTTP”) or hypertext transfer protocol secure (“HTTPS”) type request. The API 215 may receive an HTTP/HTTPS request and send an HTTP/HTTPS response back. In other embodiments, the API 215 may be configured to facilitate communication between the user interface 210 and the LCM 205 using other or additional types of communication protocols. In other embodiments, the user interface 210 may be configured to access the LCM 205 in other ways.

Thus, the user interface 210 provides a user interface that facilitates human-computer interaction between the users and the LCM 205. Thus, the user interface 210 is configured to receive user inputs from the users via a graphical user interface (“GUI”) of the management system and transmit those user inputs to the LCM 205. The user interface 210 is also configured to receive outputs/information from the LCM 205 and present those outputs/information to the users via the GUI of the management system. The GUI may present a variety of graphical icons, visual indicators, menus, visual widgets, and other indicia to facilitate user interaction. In other embodiments, the user interface 210 may be configured as other types of user interfaces, including for example, text-based user interfaces and other man-machine interfaces. Thus, the user interface 210 may be configured in a variety of ways.

Further, the user interface 210 may be configured to receive user inputs in a variety of ways. For example, the user interface 210 may be configured to receive the user inputs using input technologies including, but not limited to, a keyboard, a stylus and/or touch screen, a mouse, a track ball, a keypad, a microphone, voice recognition, motion recognition, remote controllers, input ports, one or more buttons, dials, joysticks, etc. that allow an external source, such as the user, to send information to the LCM 205. The user interface 210 may also be configured to present outputs/information to the users in a variety of ways. For example, the user interface 210 may be configured to present information to external systems such as users, memory, printers, speakers, etc.

Therefore, although not shown, the user interface 210 may be associated with a variety of hardware, software, firmware components, or combinations thereof. Generally speaking, the user interface 210 may be associated with any type of hardware, software, and/or firmware component that enables the LCM 205 to perform the functions described herein.

Referring still to FIG. 2, the LCM 205 includes a framework 220 and one or more modules 225 (e.g., plug-ins) that may be configured to perform inventory and various update operations. Although the framework 220 and the modules 225 are shown as separate components, in some embodiments, those components may be integrated together, and the integrated component may perform the functions of the separate components, as disclosed herein. The framework 220 may be configured as a download manager for the modules 225. The framework 220 may act as an intermediary between a component being updated and the modules 225. Each of the modules 225 may include libraries, images, metadata, checksums for security, and other information for updating a component of the cluster 100. In some embodiments, the LCM 205 or at least portions thereof may be part of the operating system (e.g., Acropolis Operating System) of the cluster (e.g., the cluster 100) on which the LCM is located.

In some embodiments, before performing an update, the LCM 205 may be configured to take an inventory of the components (e.g., entities) on a cluster. For example, to take inventory, the LCM 205, and particularly, the framework 220 may be configured to identify and/or display what software and firmware various entities in a cluster contain. In some embodiments, the inventory may be taken on a node when the node comes online for the first time. In other embodiments, the inventory may be taken periodically. In some embodiments, the LCM 205 may take inventory autonomously without any user input. In some embodiments, the LCM 205 may receive a user input to take inventory, and the LCM may take inventory in response to the user input. The inventory may be displayed on the user interface 210. In some embodiments, the inventory may be taken by one of the modules 225 upon direction by the framework 220.

Further, the LCM 205, and particularly the framework 220 and/or the modules 225 may be configured as, and/or operate in association with, hardware, software, firmware, or a combination thereof. Specifically, the LCM 205 may include a processing unit or processor 235 configured to execute instructions for implementing the functionalities of the LCM 205. In some embodiments, each of the framework 220 and the modules 225 may have their own separate instance of the processor 235. The processor 235 may be implemented in hardware, firmware, software, or any combination thereof. “Executing an instruction” means that the processor 235 performs the operations called for by that instruction. The processor 235 may retrieve a set of instructions from a memory for execution. For example, in some embodiments, the processor 235 may retrieve the instructions from a permanent memory device like a read only memory (ROM) device and copy the instructions in an executable form to a temporary memory device that is generally some form of random access memory (RAM). The ROM and RAM may both be part of a memory 240, which in turn may be provisioned from the storage pool 170 of FIG. 1 in some embodiments. In other embodiments, the memory 240 may be separate from the storage pool 170 or only portions of the memory 240 may be provisioned from the storage pool. In some embodiments, the memory in which the instructions are stored may be separately provisioned from the storage pool 170 and/or the memory 240. The processor 235 may be a special purpose computer, and include logic circuits, hardware circuits, etc. to carry out those instructions. The processor 235 may include a single stand-alone processing unit, or a plurality of processing units that use the same or different processing technology. The instructions may be written using one or more programming language, scripting language, assembly language, etc.

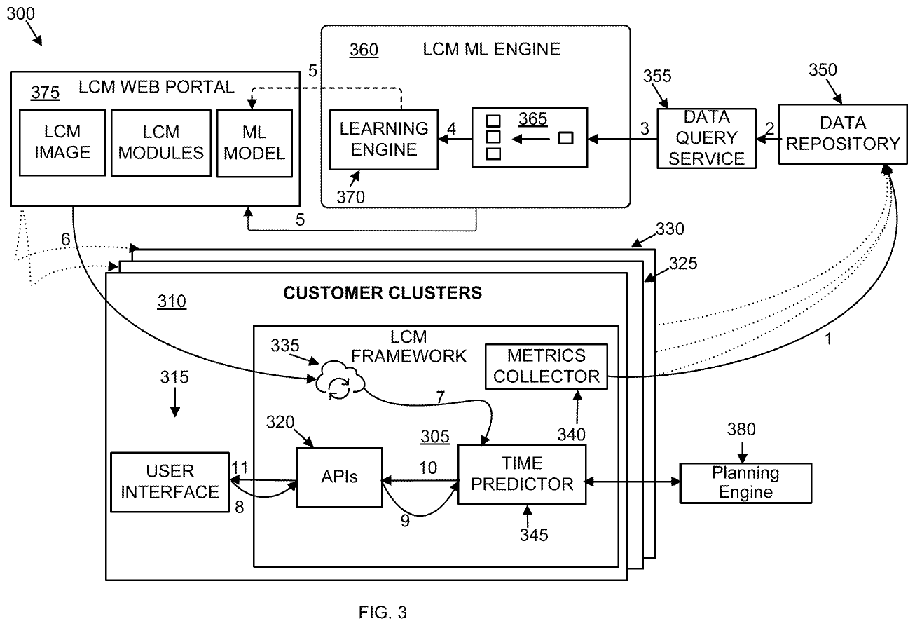

Turning now to FIG. 3, another example block diagram of an LCM 300 is shown, in accordance with some embodiments of the present disclosure. The LCM 300 shows additional details of the LCM 205 and how the LCM predicts update times, as well as plans maintenance windows. The LCM 300 shows a framework 305 that may be associated with a customer cluster 310. The framework 305 is similar to the framework 220, and therefore not described again. In some embodiments, the framework 305 may communicate with a user through a user interface 315 and API 320. The user interface 315 and the API 320 are similar to the user interface 210 and the API 215, respectively, and therefore not described again. In some embodiments, an instance of the LCM, and particularly, an instance of the framework 305 may be associated with each customer cluster.

For example, the LCM 300 of FIG. 3 shows a plurality of customer clusters, including the cluster 310 and clusters 325 and 330. Even though three customer clusters are shown in FIG. 3, in other embodiments, greater than or fewer than 3 clusters may be provided in the LCM 300. Each of the clusters 310, 325, and 330 may be similar to the cluster 100 and include similar components as the cluster 100. Each of the clusters 310, 325, and 330 may have an instance of the framework 305 (or at least portions thereof) associated therewith. Also, although not shown, each of the clusters 35 and 330 may have their own instance of the user interface (e.g., similar to the user interface 315) and APIs (e.g., similar to the API 320). Although not shown, in some embodiments, in addition to the framework 305, each of the clusters 310, 325, and 330 may also be associated with one or more modules (e.g., similar to the modules 225). Additionally, although the API 320 is shown to be part of the framework 305, in other embodiments, the API may be separate from, and associated with, the framework to facilitate communication between the user and the framework.

The framework 305 may include an auto-updater 335, a metrics collector 340, and an in-cluster upgrade time predictor 345 (referred to herein as the “time predictor 345”). Each of the auto-updater 335, the metrics collector 340, and the time predictor 345 may be configured as software, hardware, firmware, or combinations thereof. Further although not shown, in some embodiments, one or more of the auto-updater 335, the metrics collector 340, and the time predictor 345 may be associated with one or more processors and memories to perform the functions described herein. The auto-updater 335 is configured to automatically update the framework 305 whenever a new version of the framework is available. In some embodiments, the auto-updater 335 may be configured to check for upgrades before each upgrade operation is performed. In other embodiments, the auto-updater 335 may check for upgrades periodically.

If the auto-updater 335 finds that an update to the framework 305 is available, the auto-updater 335 downloads and installs the update before proceeding with the update operation. For example, in some embodiments, the auto-updater 335 may update the time predictor 345 with new data. Similarly, in some embodiments, the auto-updater 335 may be configured to check for updates and automatically update the user interface 315, the metrics collector 340, the API 320, and any other component of the framework 305 and the modules associated with the framework. In some embodiments, the auto-updater 335 may continuously check for available updates to any component of the framework 305 (and/or the modules). In other embodiments, the auto-updater 335 may be configured to check for updates periodically (e.g., before an update operation). In other embodiments, the auto-updater 335 may receive an instruction from a user via the user interface 315 and check for updates in response to that instruction. Further, upon finding a new update that is available, the auto-updater 335 may also automatically install the new update.

The metrics collector 340 may be configured to collect metrics from the underlying cluster 310, 325, 330. In some embodiments, the metrics collector 340 may be configured as an agent. The agent may be configured as a software, hardware, firmware, or a combination thereof. In some embodiments, the agent may be configured as an autonomous program that is configured for performing one or more specific and approved operations (e.g., metric collection). The agent may be associated with resources (e.g., CPU, memory, etc.) on the cluster (e.g., the cluster 310) that the agent resides on. In some embodiments, the agent may be installed on a virtual machine of the cluster (e.g., the cluster 310). In some embodiments, an instance of the agent may reside on each node of a particular cluster. In other embodiments, the agent may be installed on a node (e.g., the leader node) of the cluster and may be configured to collect metrics from all the nodes of the cluster. In some embodiments, a single agent may be configured to collect multiple types of metrics. In other embodiments, multiple agents, with each agent being configured to collect one or more types of metrics, may be associated with each cluster. In some embodiments, each agent may be configured with a configuration file that tells the agent which metrics to collect, when to collect, how to collect, where to send the collected metrics from, etc. In other embodiments, other or additional mechanisms may be used for collecting metrics from the underlying cluster (e.g., the clusters 310, 325, 330).

In some embodiments, the agent (or another mechanism that collects metrics) may be configured to poll certain databases, counters, logs, services, etc. to collect the metrics. The collected metrics may be used to predict update times and plan an upgrade. In some embodiments, the metrics collector 340 may be configured to collect metrics after an upgrade operation. In other embodiments, the metrics collector 340 may be configured to collect metrics periodically or on demand. In some embodiments, the metrics collector 340 may run in the background on the underlying cluster. In some embodiments, example metrics that the metrics collector 340 may collect may include:

1) Entity type (e.g., operating system BIOS, hypervisor, controller/service virtual machine, etc.) being upgraded.
2) Current version of the entity type.
3) Desired target version of the entity type.
4) Time of the day when the upgrade was last performed.
5) Total time (e.g., in seconds) taken for the last upgrade to complete.
6) Number of pre-checks executed during the last upgrade.
7) Size (e.g., in bytes) of image downloaded during the download stage of the last upgrade.
8) Granular time (e.g., in seconds) for each upgrade stage during the last upgrade.
Time taken for each pre-check during the last upgrade.
Time taken for the download of each of the modules in the last upgrade.
Time taken for each pre-action preceding the last upgrade.
Time taken for each of the upgrade modules during the last upgrade.
Time taken for each post-action after the last upgrade.
   9) Number of user virtual machines evacuated per node for the upgrade during the last upgrade.
   10) Cluster size (number of nodes).
   11) Appliance hardware models that make the cluster (e.g., NX3060).
   12) Hypervisor type (e.g., Acropolis hypervisor, Hyper-V, ESX, etc.) running on the cluster.
   13) Hypervisor version running on the cluster.
   14) Operating system version running on the cluster.
   15) LCM version running on the cluster.
   16) CPU load percentage during the last upgrade (e.g., bucketized range, 0-10, 10-20, 20-30 for the controller/service virtual machine, host machines).
   17) Disk utilization during the last upgrade (e.g., normalized disk input/output operations, normalized disk bandwidth, etc.).
   18) RAM memory utilization during the last upgrade (e.g., free memory in the controller/service virtual machine, etc.).
   19) Host model number of the host machine (e.g., input/output device count).
   20) Network bandwidth.
   21) Cloud substrate type.

In other embodiments, the metrics collector 340 may collect other or additional types of metrics. Generally speaking, the metrics collected may be classified into either entity metrics, hardware metrics, or upgrade operations metrics. In some embodiments, the metrics collected from each cluster (e.g., the clusters 310, 325, 330) may be used to train/create a machine learning model, which may then be used to predict upgrade times and plan a maintenance window, as discussed further below. Specifically, in some embodiments, the metrics collector 340 may transmit the collected metrics to a data repository 350. In some embodiments, the metrics collector 340 may send the collected metrics to the data repository 350 as soon as the metrics are collected. In other embodiments, the metrics collector 340 may send the collected metrics to the data repository 350 periodically (e.g., every 6 hours or at other pre-determined time intervals). Further, in some embodiments, the metrics may be collected after completing each upgrade operation. In other embodiments, metrics may be collected at other time intervals.

The data repository 350 is configured to at least store the collected metrics from multiple clusters (e.g., the clusters 310, 325, 330). For example, the data repository 350 may receive the collected metrics from the clusters 310, 325, and 330, and at least temporarily store those metrics. In some embodiments, the data repository 350 may include one or more storage devices. Further, in some embodiments, the data repository 350 may be located in a cloud or on-premises. In some embodiments, the data repository 350 may be configured to perform certain pre-processing on the collected metrics. For example, in some embodiments, a data query service 355 may be configured to convert any non-numeric collected metrics into numeric metrics. In other embodiments, the data query service 355 may be configured to convert the format of certain collected metrics into standardized or normalized formats. For example, if the supported hypervisor types include AHV, ESX, Hyper-V, Zen, they may be normalized to integers 1, 2, 3, and 4, respectively. Similar techniques may be applied for every metric type. In other embodiments, yet other types of pre-processing may be performed. In some embodiments, the pre-processing that is performed may be based on the machine learning algorithm that is used. In other embodiments, the pre-processing may be based on other factors.

Further, even though the data query service 355 is described as performing the pre-processing, in other embodiments, the metrics collector 340 or another component may perform the pre-processing. In yet other embodiments, the pre-processing may not be performed. The data query service 355 may be configured to receive the collected metrics (e.g., at pre-determined time intervals) from the data repository 350 and supply those collected metrics to a machine learning engine 360. In some embodiments, the data query service 355 and/or the machine learning engine 360 may reside in a cloud or on-premise. In some embodiments, the data query service 355 may be configured to automatically retrieve the collected metrics (e.g., the newest set of metrics received from the metrics collector 340) from the data repository 350 and send the retrieved metrics to the machine learning engine 360. In other embodiments, the machine learning engine 360 may be configured to periodically query the data query service 355 for the collected metrics, and upon receiving the query from the machine learning engine, the data query service may retrieve the collected metrics from the data repository 350 and send the retrieved metrics to the machine learning engine. In some embodiments, metrics for each upgrade operation may include the type of upgrade being performed, the entity being upgraded, the cluster identifier (e.g., universally unique identifier), etc. In some embodiments, to retrieve the metrics from the data repository 350, the data query service 355 may send a request to the data repository. In some embodiments, the request may identify which metrics to retrieve. In some embodiments, the request may additionally or alternatively identify the time period from which to retrieve the metrics. In some embodiments, the request may additionally or alternatively identify the cluster (e.g., the cluster 310, 325, 330) whose metrics are to be retrieved. In some embodiments, all newly added metrics may be retrieved.

For example, in some embodiments, not all metrics may be relevant for all types of upgrades. In some embodiments, to avoid a bias (under fit) or high variance (over fit) in the machine learning engine 360, each upgrade type may be associated with metrics that may be considered relevant for that upgrade. For example, in some embodiments, metrics such as a number of virtual machines evacuated for the upgrade may not be applicable for upgrades that do not require the virtual machines to be migrated to another mode during upgrades. Thus, in such types of upgrades, metrics associated with the number of virtual machines evacuated may not be relevant. As another example, for BIOS updates, the virtual machines may need to be evacuated. Thus for BIOS updates, the number of virtual machines evacuated, as well as network bandwidth may be critical. On the other hand, for service upgrades which happen on the cluster, the virtual machines may not need to be migrated. Therefore, the number of virtual machines evacuated and network bandwidth may not be critical.

In some embodiments, the metrics that are considered relevant for a particular upgrade may be predefined and programmed within the machine learning engine 360 and/or the data query service 355. In some embodiments, an initial set of metrics that may be considered relevant to a particular type of upgrade may be selected. As the machine learning engine 360 is trained, additional types of metrics considered relevant for that type of upgrade may be included. By defining metrics relevant for each type of upgrade, a bias (e.g., under fit) or high variance (e.g., over fit) in the training model of the machine learning engine 360 may be avoided. Upon receiving the request, the data repository 350 may retrieve the requested metrics and send the requested metrics to the data query service 355.

In some embodiments, the retrieved metrics from the data query service 355 may be received by a metric splitter 365 of the machine learning engine 360. The metric splitter 365 may classify each category of received metrics into input metrics or output metrics. For example, in some embodiments, for the metrics mentioned above, the metric splitter 365 may categorize those metrics as follows:

| Inputs | Outputs |
|---|---|
| Entity metrics | Granular time for each upgrade stage used |
| The entity type getting upgraded. | for training, test and prediction: |
| Current version of the entity. | Time taken for each pre-check. |
| Desired target version of the entity. | Time taken for the downloads. |
| Hardware details | Time taken for each pre-action |
| CPU load percentage (bucketized | (workflow needed to move the |
| range 0-10, 10-20, 20-30 . . . ) | system into an upgrade ready state). |
| CVM | Time taken for the actual upgrade. |
| Hosts | Time taken for each post action |
| Disk utilization (similar bucketized | (workflow needed to move the |
| range) | system into steady state) |
| Disk input/output | |
| operations (normalized) | |
| Disk bandwidth | |
| (normalized) | |
| RAM memory utilization (similar | |
| bucketized range) | |
| CVM | |
| Free memory | |
| Host Model Number (involves | |
| input/output device count, which may | |
| contribute to actions like reboots) | |
| Network bandwidth | |
| Cloud substrate type | |
| Hypervisor type | |
| Hypervisor version | |
| Upgrade operations | |
| Number of pre-checks executed. | |
| Size of images downloaded during the | |
| download stage | |
| Number of user virtual machines | |
| evacuated per node for the upgrade. | |
| Cluster size (number of nodes) | |
| Operating system version | |
| LCM version | |

The metrics listed in the “inputs” column in the table above may be those fields that are input into a learning engine 370 of the machine learning engine 360. The metrics listed in the “outputs” column in the table above are produced as outputs from the learning engine 370. The metrics listed in the “outputs” column in the table above are also input into the learning engine 370 (e.g., for training). For example, the learning engine 370 may run multiple iterations on multiple datasets to continuously train a time prediction model. The outputs from a previous iteration of computations from the learning engine 370 may be used as inputs into the next iteration of the learning engine computations. Thus, the outputs mentioned above are continuously updated and refined to train the time prediction model. Further, in some embodiments, multiple machine learning models may be trained using the inputs and the outputs in the table above.

In some embodiments, the learning engine 370 (e.g., the time prediction model) may be trained periodically. For example, in some embodiments, the learning engine 370 may be trained every few hours. In other embodiments, the learning engine 370 may be trained every few days or at other predetermined time periods. By virtue of continually training the learning engine 370, the accuracy of predictions of the learning engine 370 and the metrics that may be used for predicting each type of upgrade may be continuously refined and improved. In some embodiments, the time prediction model of the learning engine 370 may be trained with different set of metrics/algorithms against a training set and test set. The set of metrics/algorithm which yields the best results on test data may be selected as the time prediction model. Thus, in some embodiments, the learning engine 370 may be trained with different set of metrics and/or different machine learning/artificial intelligence algorithms.

Specifically, to train the learning engine 370 for a particular type of upgrade, in some embodiments, the input data (e.g., metric data received from the data repository 350) that is input into the learning engine 370 may be split into a training set and a test set (e.g., by the metrics splitter 365). The learning engine 370 may be trained by applying various machine learning algorithms on the training set. After the learning engine 370 is trained using a particular algorithm and the training set, the learning engine may be applied using the particular algorithm to the corresponding test set. The algorithm that yields the best results relative to other algorithms may be selected as the algorithm for the time prediction model. Similarly, the metrics in the test/training sets that yield the best results may be selected for the time prediction model for the particular type of upgrade.

In some embodiments, the learning engine 370 may be trained using a single training set and varying the machine learning algorithms that are applied on the training set to identify the most suitable algorithm. In other embodiments, a single machine learning algorithm may be applied to various training sets to identify the most suitable set of metrics for a particular type of upgrade. In yet other embodiments, the learning engine 370 may be trained to vary both the training set and the machine learning algorithms. In some embodiments, the algorithms that may be used to train the learning engine 370 may include a Feedforward Artificial Neural Network, particularly a Multi-layer Perceptron ANN (artificial neural network), with three layers of thirteen neurons each. In other embodiments, other types of neural networks or machine learning algorithms, including other configurations of the Feedforward Artificial Neural Network, other neural networks, or other machine learning algorithms may be used.

Further, in some embodiments, as part of training the learning engine 370, the weights that are applied to the various collected metrics in the machine learning algorithm may be modified. In other words, the weights may be dynamic. Specifically, some metrics may contribute more to the upgrade prediction than other metrics. For example, updating disk firmware may require evacuating (e.g., migrating, pausing, etc.) workloads off a node or having these workloads not create input-output traffic on a node. Evacuating these workloads may impact the total amount of time that a firmware upgrade takes compared to another type of upgrade (e.g., software upgrade) that may not require the workloads to be evacuated. As another example, a cluster (e.g., Prism Element of Nutanix) may use local storage to store artifacts needed for an LCM upgrade, while a management system (e.g., Prism Central of Nutanix) may use external storage to store the artifacts. The difference in locations where the artifacts may be stored may vary the time needed to stage the artifacts into an update environment. Thus, depending upon the type of upgrade, different metrics may have a different impact on the total upgrade time prediction. To quantify the effect of the differences in these metrics, different weights may be assigned to each metric (also referred to herein as an “attribute”).

For example, in some embodiments, certain types of metrics may be accorded a higher weight than other types of metrics for a particular type of upgrade. Similarly, in some embodiments, local cluster data for a similar upgrade operation might align closer to the global average and may be accorded a greater weight than global cluster data (e.g., data from multiple clusters). In some embodiments, recent data may be accorded greater weight than older data (decaying information). In other embodiments, other factors may be used to accord weights to the various metrics input into the learning engine 370. In some embodiments, the weights that are used during training the learning engine 370 may be determined internally by the neural network (e.g., the machine learning algorithm). For example, in some embodiments, a cost function for the average difference between computed results obtained from the training set and actual outputs generated by the neural network may be defined. The neural network may be configured to optimize this cost function by tuning the weights for different layers. In other embodiments, the weights may be determined in other ways. Thus, optimized weights to be applied may be determined during training.

Thus, the learning engine 370 continuously receives the collected (and potentially pre-processed) metrics as inputs (including outputs from previous iterations) and generates outputs indicative of the total time for each phase, step, or stage of the update process (e.g., pre-check, download of modules, pre and post action, actual upgrade, etc.), as shown in the output column of the table above, for each type of upgrade. The outputs from the learning engine 370 (e.g., the time prediction model) may be made available to a user through a web portal 375 as a binary. In some embodiments, the web portal 375 may be an administrator interface. In some embodiments, the web portal 375 may be an http server hosting various images, modules, and machine learning models that may be needed by the framework 305. In some embodiments, the web portal 375 may be hosted using a web application (e.g., Amazon S3) and accessed using a URL. In some embodiments, the web portal 375 may be used to download and install an image of the LCM 205 on the user's device. The web portal 375 may also be used to access the various modules (e.g., the modules 225), as well as the time prediction model. In some embodiments, any upgrades or fixes may be made available to the web portal 375, and the auto-updater 335 may check the web portal for any updates, as discussed above. The binary may also be downloaded/applied to the time predictor 345 by the auto-updater 335.

Further, the web portal 375, the machine learning engine 360, the data query service 355, and the data repository 350 may all be located in a centralized location providing upgrade time prediction services to a plurality of clusters, avoiding the need for each cluster to have individual instances of the web portal 375, the machine learning engine 360, the data query service 355, and the data repository 350. Further, the centralized location may take advantage of data (e.g., metrics) received from multiple clusters, thereby having greater access to data for training the learning engine 370.

The time predictor 345 may then be used to compute total upgrade times on the underlying cluster (e.g., the cluster 310) for each upgrade type or a group of upgrade types. Specifically, in some embodiments, for each type of upgrade or a group of upgrade types, the time predictor 345 may receive the outputs indicating total time for each phase or step of the update process for that type of upgrade from the learning engine 370. The time predictor 345 may then use the outputs to calculate a total upgrade time for the type of upgrade or a group of upgrade types. For example, in some embodiments, the time predictor 345 may apply the following formula to compute the total upgrade time:

$$total upgrade time = pre \text{-} check time + module download time + {\sum }_{over all batches} ( pre \text{-} action time + upgrade time + post \text{-} action time )$$

In the formula above, pre-check time is the time taken to complete a pre-check. A pre-check includes one or more tasks or checks that are performed before an upgrade is commenced. If the pre-check fails, the upgrade is not performed. The pre-check confirms that all prerequisites for the upgrade are satisfied and that the component being upgraded is in condition to receive the upgrade. For example, in some embodiments, the pre-check may include verifying that the operating system is compatible with the upgrade, verifying that the entity being upgraded is healthy, checking that no nodes are in a maintenance mode (e.g., currently undergoing another upgrade), the verifying that the entity has sufficient space to receive the upgrade, verifying that the entity is reachable (e.g., verifying the IP address), verifying that the virtual machine monitor (e.g., hypervisor) is healthy, confirming that no upgrade is in progress, and any other tasks that may be needed or considered suitable to perform to ensure the success of the upgrade.

Further, in the formula above, module download time is the time to check which modules (e.g., the modules 225) may be needed to perform the upgrade and download those modules. In some embodiments, the module download time may also include the time needed to check for any updates to the framework (e.g., the framework 220) and the time needed to download the updates. Pre-action time in the formula above is the time during which any tasks that are needed to ready the entity for the upgrade are performed. Example pre-actions may include entering maintenance mode on host or CVM, acquiring a shutdown token to re-boot the host or CVM, booting into a special environment for upgrades such as Phoenix or IVU, stopping one or more system services, taking backups, forwarding storage traffic from the node being disrupted to healthy counterparts etc. Similarly, in the formula above, post-action time may be the time during which post-actions are performed after the entity has been upgraded. Example post-actions may include exiting out of maintenance module on host or CVM, booting out of the special environment used for upgrades such as Phoenix or IVU, (re)starting one or more services, waiting for services to start up, restoring storage traffic etc. Batch or batches in the formula above means a group of available upgrades. In some embodiments, similar upgrades may be grouped together into a batch. For example, in some embodiments, upgrades that require the host or controller/service virtual machine to be put into a maintenance mode may be grouped together into a batch, thereby optimizing the number of times the host or controller/service virtual machine needs to be put in the maintenance mode.

For example, in some embodiments, a user may select a group of desired upgrades. The group of desired upgrades may be divided into batches. For each batch, a sum of the pre-action time, update time for all modules used in the batch, and post-actions time may be computed. The upgrade time for all modules may include any time that may be needed to update the modules that are used for the upgrade. The total upgrade time may be the upgrade time for a selected set of upgrades (e.g., based on user selection). Thus, for a set of user selected upgrades, the time predictor 345 computes and outputs the total upgrade time for that set of user selected upgrades. The outputs from the time predictor 345 may then be input into a planning engine 380 for determining a maintenance (e.g., upgrade) plan.

In some embodiments, the planning engine 380 may be part of the framework 305. In other embodiments, the planning engine 380 may reside in a centralized location (e.g., cloud, on-premise, etc.). Further, the planning engine 380 may be configured as software, hardware, firmware, or combination thereof. The planning engine 380 may receive user inputs through the user interface 315 and based on those user inputs, the planning engine 380 may determine an upgrade plan in accordance with the data received from the time predictor 345. In some embodiments, the planning engine 380 may be implemented to solve a Knapsack problem/Scheduling problem. For example, given a desired start time for an upgrade and/or the upgrade window (e.g., maintenance window), the planning engine 380 determines the upgrades that are available and receives the total update times as generated by the time predictor 345. Based on the inputs from the time predictor 345, the planning engine 380 picks the most suitable upgrades, based on several factors such as dependencies, respective requirements for reboot and workload migration, reboot of host or controller/service virtual machine count, need for booting into custom images, etc. Additionally, in some embodiments, the planning engine 380 may provide recommendations to users of upgrades that may fit within the user's maintenance window. In some embodiments, the planning engine 380 may also present strategies based longest upgrade first, locality of upgrade (e.g., all upgrades on a particular node be completed before moving to another node), etc. to the user to select from. An example of how the planning engine 380 may configure a maintenance plan is discussed below.

It is to be understood that only certain elements of the LCM 300 are shown in FIG. 3. Nevertheless, other components that may be needed or considered useful to have in performing the functions described herein may be provided in the LCM 300.

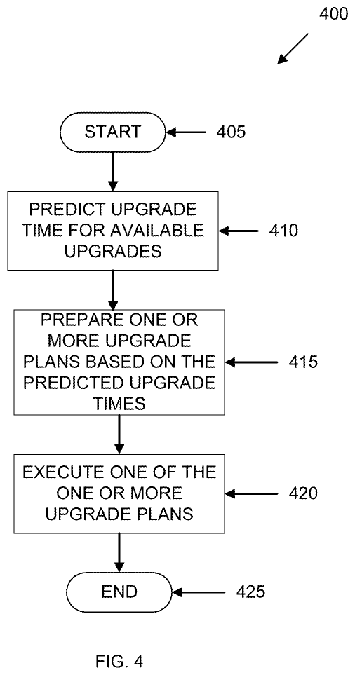

Referring now to FIG. 4, an example flowchart outlining operations of a process 400 is shown, in accordance with some embodiments of the present disclosure. The process 400 may include other or additional operations depending upon the embodiment. The process 400 may be implemented by the LCM 300, and particularly by the framework 305 and the planning engine 380. Upon starting at operation 405, the framework 305 (e.g., the time predictor 345) may predict upgrade time for each type of upgrade to be applied to a particular cluster (e.g., the cluster 310). In some embodiments, the time predictor 345 may predict the individual upgrade time for each type of upgrade based upon the outputs received from the machine learning engine 360. In some embodiments, before the operation 410, the auto-updater 335 may check the web portal 375 to determine if any updates to the framework 305 are available. If updates are available, the auto-updater 335 may download the updates. In some embodiments, the auto-updating operation may be part of the inventory operation discussed above.

In some embodiments, as part of the inventory, the framework 305/the planning engine 380 may also determine what updates that are available and that need to be applied to a cluster. For example, to update the cluster 310, the framework 305/the planning engine 380 may determine what updates are available to be applied to the cluster 310. For each of the updates that are available to be applied to the cluster 310, the time predictor 345 may determine an estimated or predicted upgrade time based upon the outputs received from the learning engine 370. The time predictor 345 may send the outputs to the planning engine 380.

At operation 415, the planning engine 380 determines one or more upgrade plans. In some embodiments, the planning engine 380 receives a user input of a desired maintenance window. For example, in some embodiments, the planning engine 380 may receive the number of hours that a user would like to schedule as the maintenance window. In some embodiments, the planning engine 380 may also receive desired updates from the user. For example, in some embodiments, the user may select one or more updates that are available to be applied to the cluster 310. In some embodiments, the user may be provided a list of available updates. The user may select from that list those updates that the user desires to apply to the cluster 310. The planning engine 380 also receives the outputs from the time predictor 345. From the received outputs, the planning engine 380 may determine the estimated upgrade times of each of the user selected updates that the user desires to apply to the cluster 310. In some embodiments, the planning engine 380 may also sort the user selected updates based on criticality. For example, in some embodiments, each available update may be categorized in one of multiple categories such as “emergency,” “critical,” or “recommended.” In some embodiments, the updates categorized as “emergency” may be considered the most urgent updates to install, followed by updates classified as “critical,” then “recommended.” In other embodiments, other or additional categories of updates may be used.

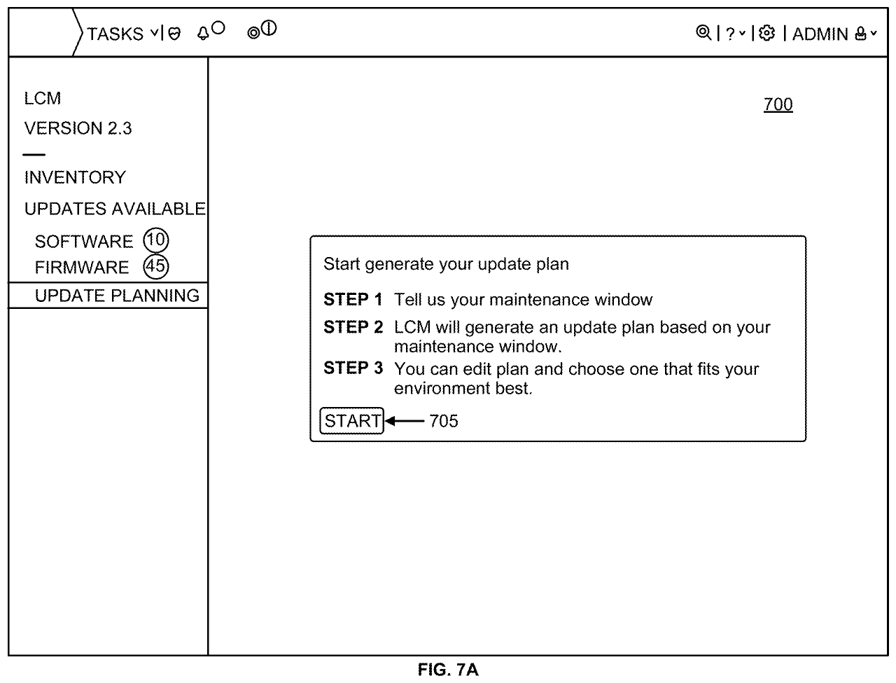

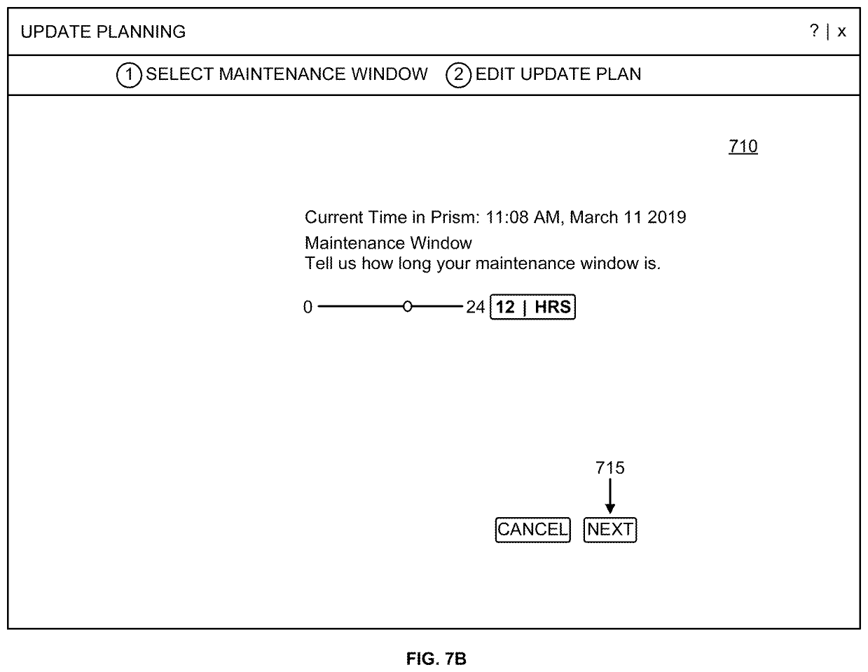

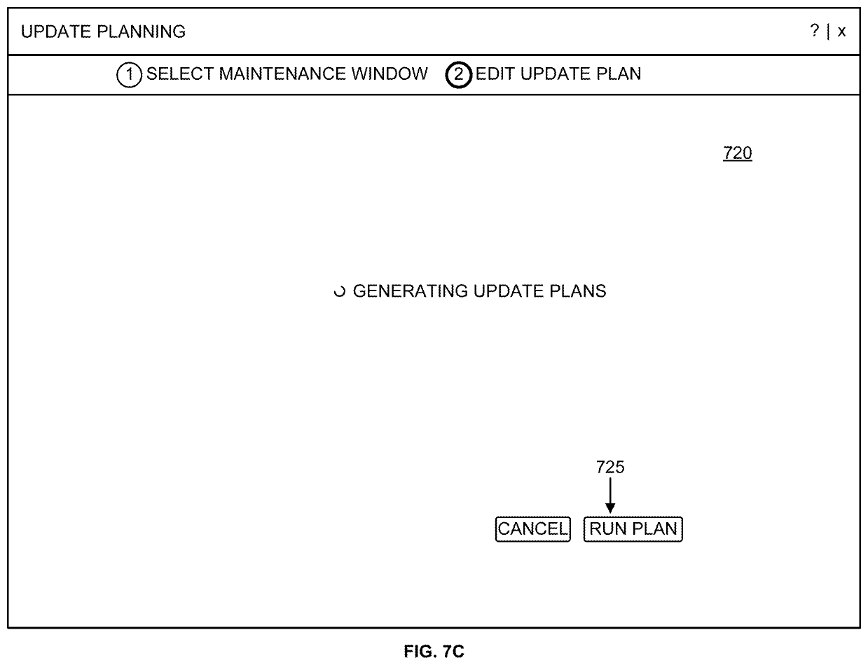

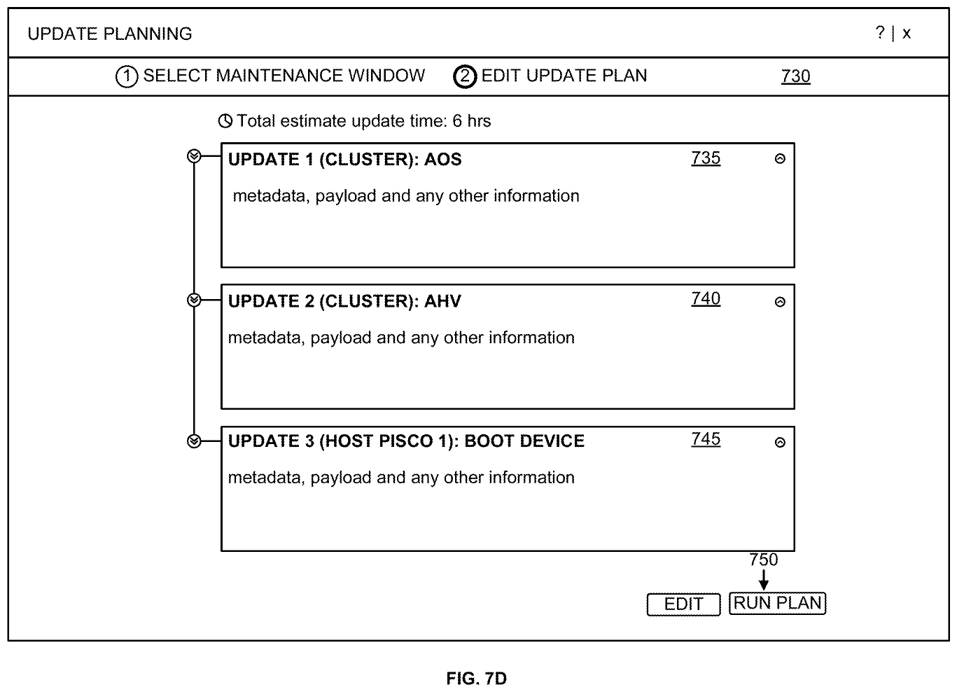

In some embodiments, by sorting the updates according to their designated category, the planning engine 380 attempts to prioritize the application of those updates that are most urgent. Then, based upon the number of hours in the maintenance window and the estimated upgrade time of each of the user selected upgrades in the order of priority, the planning engine 380 determines one or more upgrade plans. The planning engine 380 may make the upgrade plan(s) available to the user on the user interface 315. The user may select a particular upgrade plan for execution. In some embodiments, the user may edit the selected plan before execution. Upon receiving the user selection, the framework 305 executes the upgrade plan at operation 420. To execute the upgrade plan, the framework 305 may perform one or more actions, as shown in FIGS. 7A and 7B, and described in greater detail in U.S. application Ser. No. 15/872,792, filed on Jan. 16, 2018, the entirety of which is incorporated by reference herein. Upon completing execution, the process 400 ends at operation 425.

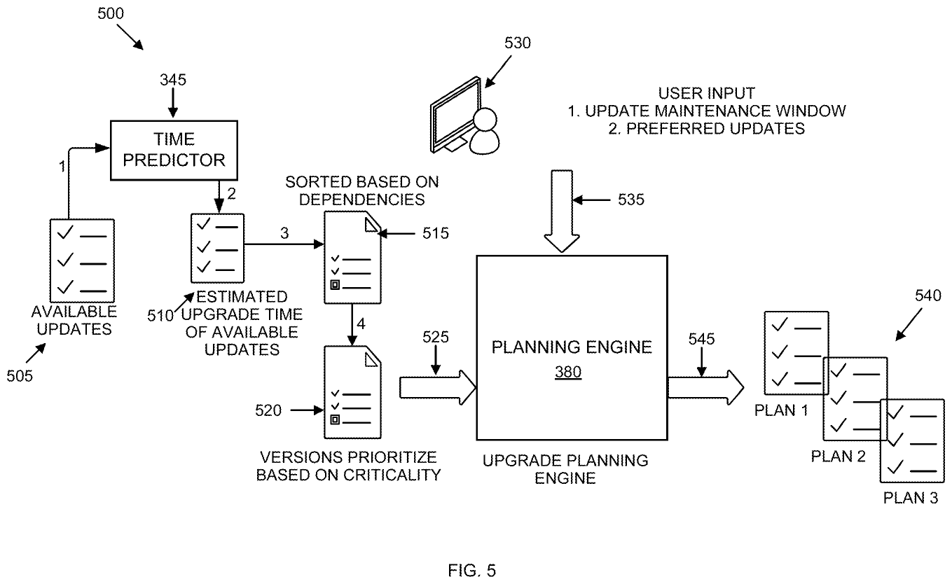

Turning now to FIG. 5, an additional flow diagram outlining a process 500 is shown, in accordance with some embodiments of the present disclosure. The process 500 may be used to present one or more upgrade plans to a user. Thus, the process 500 may implement an “upgrade assistant” to help a user select the most suitable upgrades for a desired maintenance window. The process 500 may include other or additional operations depending upon the particular embodiment. The process 500 may start with inventory which may determine available upgrades for each software and firmware, and which satisfy dependencies. Thus, the time predictor 345 may know available upgrades 505 for a particular entity (e.g., underlying cluster). In some embodiments, the updates may include BIOS (Basic Input/Output System) updates, BMC (Baseboard Management Controller) updates, Data Drive and HBA (Host Bus Adaptor) Controller updates, SATA updates (e.g., SATA drive, hypervisor boot drive, etc.), M.2 Drive (mSATA2, hypervisor boot drive) updates, NIC (Network Interface Controller) updates, OS (Operating System) updates etc.

Further, each upgrade may be associated with a set of tasks (e.g., pre-action, post-action, upgrade tasks) that may need to be performed for completing that upgrade. For example, BIOS, BMC, SATA DOM, Data Drive and HBA, M.2 Drive upgrades may each include putting the controller/service virtual machine of a particular node in a maintenance mode, migrating all guest virtual machines from the particular node to another node, restarting the particular node into upgrade mode (e.g., Phoenix ISO), apply the upgrade, reboot the controller/service virtual machine to bring the controller/service virtual machine out of the maintenance mode and apply the upgrade. Once out of the maintenance mode, any migrated guest virtual machines may be migrated back to the particular node. Similarly, other types of upgrades may have associated tasks.

Thus, the time predictor 345 may determine the available upgrades 505 and compute an upgrade time 510 for each of the available upgrades. In some embodiments, the time predictor 345 may batch two or more of the available upgrades 505 to compute the upgrade time 510 for the batch. For example, in some embodiments, if the time predictor 345 determines that there is a BIOS upgrade and a BMC upgrade available, the time predictor 345 may determine the upgrade time 510 needed for the BIOS upgrade alone and the upgrade time needed for the BMC upgrade alone. In some embodiments, the time predictor 345 may also determine that both BIOS and BMC upgrades require a subset of similar tasks to be performed. For example, the time predictor 345 may determine that both BIOS and BMC upgrades require a cold reboot of a node and workload migration (e.g., migration of the virtual machines from the node). Thus, the time predictor 345 may batch the BIOS and BMC upgrades together and determine the upgrade time 510 for the batch. In some embodiments, the time predictor 345 may determine the upgrade time 510 using the formula discussed above.

Therefore, the time predictor 345 may output multiple values of the upgrade time 510 (e.g., a first upgrade time for BIOS upgrade only, a second upgrade time for BMC upgrade only, a third upgrade time for the BIOS/BMC batch upgrade). In some embodiments, the time predictor 345 may also sort the available upgrades 505 based on dependencies 515 and/or criticalities 520. For example, an upgrade that is dependent upon another upgrade may be ranked lower. Similarly, more critical upgrades may be ranked higher. For example, a BIOS firmware may depend on BMC firmware, AHV (Acropolis hypervisor) may depend on AOS (Acropolis Operating system), cluster health check may depend on AOS, etc. The time predictor 345 may send the available upgrades 505 that have been sorted based on the dependencies 515 and/or the criticalities 520, as well as their respective upgrade times 510 (including the batch upgrade times) to the planning engine 380 at operation 525. In some embodiments, the sorting of the available upgrades 505 may be performed by the planning engine 380.

The planning engine 380 may thus receive the available upgrades 505 and the upgrade times 510 from the time predictor 345. The planning engine 380 may also receive a maintenance window 530 from a user at operation 535. As discussed above, a maintenance window may be a period of time that the user has available for installing one or more upgrades. Based on the maintenance window 530 and the inputs from the time predictor 345, the planning engine 380 determines one or more upgrade plans 540 at operation 545. The one or more upgrade plans 540 that the planning engine 380 suggests may be based upon various factors, as discussed above. For example, in some embodiments, at least one of the one or more upgrade plans 540 may be based on a longest upgrade. In other words, in some embodiments, the planning engine 380 may determine which upgrade (e.g., BIOS, BMC, or BIOS/BMC batch) takes the longest time to upgrade. If that longest time is within the maintenance window, the planning engine may suggest the upgrade with the longest time as one upgrade plan. Depending upon the difference between the longest time and the maintenance window, the planning engine 380 may club other upgrades as well in that upgrade plan. For example, if the planning engine 380 determines that the BIOS/BMC batch takes the longest to upgrade (e.g., 60 minutes) and the maintenance window is 90 minutes, the planning engine may identify any other upgrade that may be completed within the remaining 30 minutes, and club that upgrade with the BIOS/BMC upgrade in the same upgrade plan.

In other embodiments, the planning engine 380 may determine the one or more upgrade plans 540 based on locality of upgrade. For example, the planning engine 380 may select all upgrades that are to occur on the same node and that fit into the maintenance window into a single plan. For example, if the planning engine 380 determines that both BIOS and BMC upgrades are both to be applied to Node A and take about a total of 60 minutes to complete in the maintenance window of 90 minutes, the planning engine may club the BIOS and BMC upgrades in a single upgrade plan. Further, if the planning engine 380 determines that another upgrade to be applied to Node B may be completed within the remaining 30 minutes, the planning engine may club that upgrade with the BIOS/BMC upgrades in the same upgrade plan.

In some embodiments, the one or more upgrade plans 540 may additionally or alternatively be based on the dependencies 515 and/or the criticalities 520. For example, the planning engine 380 may include more critical upgrades and/or upgrades that other upgrades may be dependent upon in the one or more upgrade plans 540. The planning engine 380 may present the one or more upgrade plans 540 to the user (e.g., on the user interface 315). The user may select one of the one or more upgrade plans 540 for execution.

Simply as an example and without intending to be limiting in any way, say there are seven entities of different types to be upgraded across three nodes (A, B, C) in a cluster. The available upgrades (e.g., the available upgrades 505) are:

AOS (cluster wide component)->requires all controller/service virtual machines on the cluster to be rebooted;
BIOS (on nodes A, B)->requires cold reboot of the nodes+workload migration;
BMC (on nodes A, B and C)->requires cold reboot of the node+workload migration;
NIC->on node A->requires host maintenance mode.

For the available upgrades above, the time predictor 345 may compute the upgrade time 510 as follows:

AOS total upgrade time=30 minutes (AOS upgrade time: 10 (minutes)*3 (nodes))+15 minutes (controller/service virtual machine reboot time: 5 (minutes)*3 (nodes))=45 minutes;
BIOS total upgrade time=10 minutes (upgrade time)+36 minutes (workload migration time)+10 minutes (cold reboot time)=56 minutes per node;
BMC=5 minutes (upgrade time)+36 minutes (workload migration time)+10 minutes (cold reboot time)=51 minutes per node;
BIOS/BMC batched=15 minutes (10 minutes upgrade time for BIOS and 5 minutes for BMC)+36 minutes (workload migration time)+10 minutes (cold reboot time)=61 minutes per node;
NIC=12 minutes (upgrade time)+20 minutes (maintenance mode transition time)=32 minutes per node.

Based on the maintenance window time (e.g., 2.5 hours) and the strategy chosen, the planning engine 380 may provide the following two upgrade plans (e.g., the one or more upgrade plans 540):

Longest upgrade first: BIOS/BMC batched on Nodes A and B (122 minutes (about 2 hours))

Locality of upgrade: BIOS/BMC batched on Node A, NIC on node A, AOS upgrade on cluster (137 minutes (about 2 and a half hours))

Both plans may be completed within the maintenance window of 150 minutes (about 2 and a half hours). When the planning engine 380 receives the user selection, the framework 305 may implement the selected upgrade plan.

In some embodiments, the user may also select desired upgrades to install in addition to the maintenance window. The user selected upgrades may be input into the time predictor 345 for computing the upgrade time 510 for the user selected upgrades as discussed above. The planning engine 380 may then determine the one or more upgrade plans 540 based on the upgrade time 510 and the maintenance window, with each plan including one or more of the user selected upgrades. In some embodiments, the time predictor 345 and the planning engine 380 may re-compute the estimated total upgrade time upon receiving a selection of an upgrade plan from the user, allowing the users more flexibility in picking more critical upgrades over allowed upcoming maintenance window, and ensuring that upgrades do not extend beyond the planned maintenance time window.

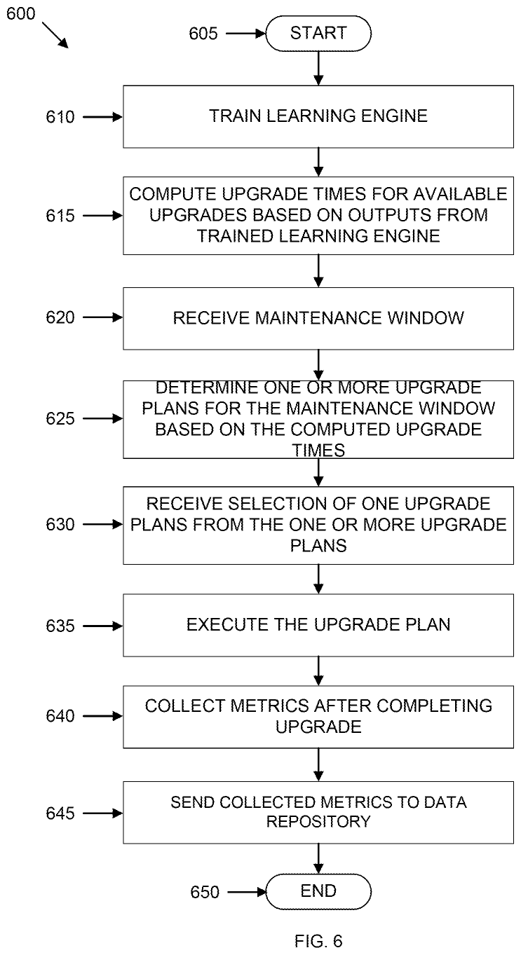

Turning now to FIG. 6, an example flowchart outlining a process 600 is shown, in accordance with some embodiments of the present disclosure. The process 600 may be used to plan and implement upgrades using the LCM 300 for a particular upgrade (e.g., BIOS, BMC, NIC, etc.). The process 600 may include other or additional operations depending upon the particular embodiment. Upon starting at operation 605, the learning engine 370 is trained at operation 610, as discussed above. Upon completing training, the learning engine 370 may send outputs indicating times needed for completing various steps of the particular upgrade to the time predictor 345 of each cluster (e.g., the clusters 310, 325, 330). At operation 615, the time predictor 345 of a cluster (e.g., the clusters 310, 325, 330) receives the outputs from the learning engine 370 and computes the upgrade time 510 for the available upgrades for that cluster.

Specifically, in some embodiments, the time predictor 345 of each cluster (e.g., the clusters 310, 325, 330) may determine the available upgrades (or receive the user selected upgrades). Based on the available upgrades (or the user selected upgrades), the time predictor 345 computes the upgrade time 510, as discussed above. The time predictor 345 may send the computed upgrade times to the planning engine 380 associated with respective cluster (e.g., the clusters 310, 325, 330). At operation 620, the planning engine 380 receives a maintenance window from a user, as well as the inputs from the time predictor 345. At operation 625, the planning engine 380 determines the one or more upgrade plans 540 and presents the one or more upgrade plans to the user.

At operation 630, the planning engine 380 receives a selection of an upgrade plan from the user and sends the selection to the framework 305. The framework 305 executes the upgrade plan at operation 635. Upon completing the execution of the upgrade plan, at operation 640, the metrics collector 340 collects metrics from the underlying cluster. At operation 645, the collected metrics are sent to the data repository 350 for use with further training of the learning engine 370 and improving the accuracy of the outputs from the learning engine 370. The process 600 ends at operation 650.

Referring now to FIGS. 7A-7D, example screenshots showing how a user may plan an upgrade is shown, in accordance with some embodiments of the present disclosure. For example, FIG. 7A shows a user interface 700 that the user may use to generate an upgrade plan. The user interface 700 may be reached using the user interface 315. If the user decides to generate an update plan, the user may click on a start button 705 to open a user interface 710 of FIG. 7B. The user interface 710 may allow the user to input a maintenance window. For example, in the user interface 710 the user has selected a maintenance window of 12 hours. Upon inputting the maintenance window, the user may click on a next button 715 to reach a user interface 720 of FIG. 7C. In the user interface 720, the user may click on a run plan button 725 to generate one or more upgrade plans (e.g., the one or more upgrade plans 540). The generated one or more upgrade plans may be shown in a user interface 730 or FIG. 7D. In some embodiments, the upgrade plans may be displayed in a particular order of criticality or importance. In other embodiments, the upgrade plans may be displayed in a random order or by another criteria.

Specifically, the user interface 730 shows three upgrade plans 735-745. In other embodiments, the user interface 730 may show greater than or fewer than three upgrade plans. The user may select one of the three upgrade plans 735-745 to execute. Upon selecting one of the three upgrade plans 735-745, the user may click on a run plan button 750 to execute the plan. Thus, the LCM 300 provides an easy, convenient, effective, mechanism to the user to plan an upgrade within a desired maintenance window. In particular, FIGS. 3-7D provide a planning assistance feature of the upgrade assistant of the LCM 205. The planning assistance feature estimates the upgrades times, plans maintenance windows, and recommends appropriate upgrade plans.

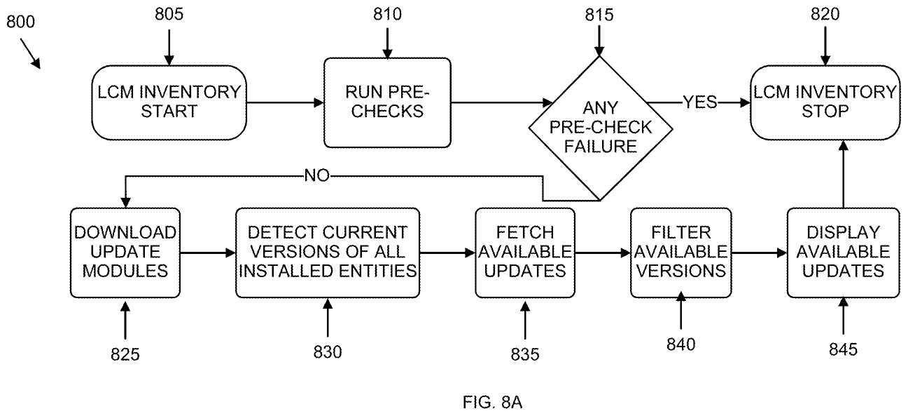

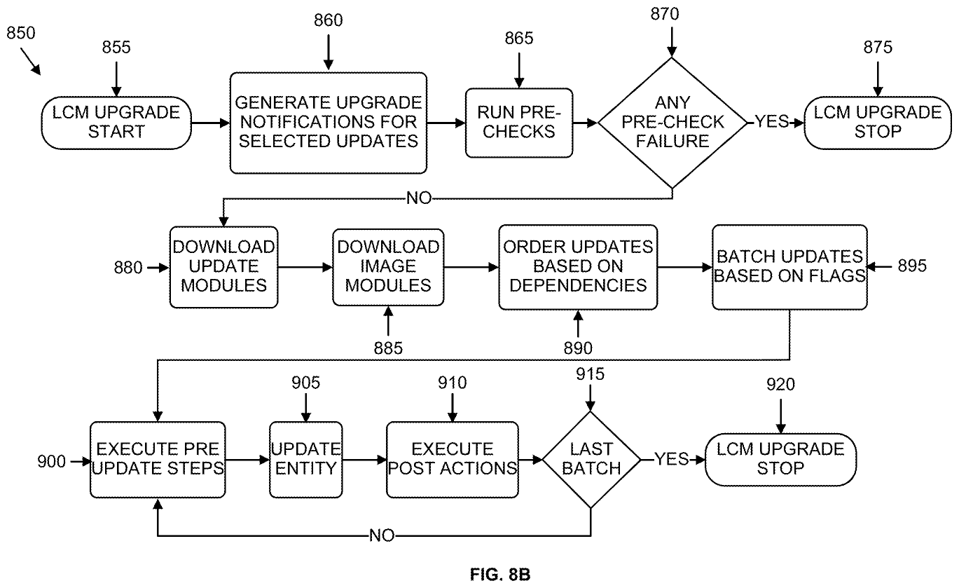

Turning now to FIGS. 8A and 8B, example flowcharts outlining processes for upgrading using LCM are shown, in accordance with some embodiments of the present disclosure. As discussed above, an upgrade to a cluster using LCM involves two functions: taking inventory and performing the updates. FIG. 8A describes the inventory function while FIG. 8B describes the update function. FIGS. 8A and 8B may be implemented by the LCM 205. Referring specifically to FIG. 8A, a process 800 outlines the inventory function. The inventory function starts at operation 805 with the LCM 205 running pre-checks at operation 810. As discussed above, the pre-checks may be performed to verify the state of the cluster. At operation 815, the LCM 205 determines if the pre-checks were successful. In other words, the LCM 205 determines if the cluster is in a state to receive an upgrade. If the pre-checks are not successful, the inventory process stops at operation 820 and the upgrade cannot be installed. If the pre-checks are successful, the process 800 proceeds to operation 825.

At the operation 825, the LCM 205 downloads the update modules (e.g., images/plugins). At operation 830 the LCM 205 determines current versions of all entities on the cluster. At operation 835, the LCM 205 determines if any updates to the entities installed on the cluster are available. The LCM 205 filters the available versions at operation 840 and displays the available updates at operation 845. The inventory function then ends.

Process 850 of FIG. 8B describes the update function. The process 850 intelligently scans entities to upgrade and schedule upgrades while honoring dependencies. The upgrade function starts at operation 855. At operation 860, the LCM 205 generates notifications for the available updates that were determined during the inventory function. At operation 865, the LCM 205 runs pre-checks and at operation 870, the LCM determines if the pre-checks were successful. If any pre-check failed at the operation 870, the process 850 stops at operation 875. On the other hand, if all the pre-checks are successful, the process 850 precedes to operation 880, where the LCM 205 downloads the update modules. At operation 885, the LCM 205 downloads images of the modules and orders updates based on dependencies at operation 890. At operation 895, the LCM 205 batches the updates based on flags and at operation 900, the LCM performs various pre-action tasks. Upon completing the pre-action tasks, the LCM 205 updates the entity undergoing upgrading at operation 905. At operation 910, the LCM 205 executes post-action tasks upon the updating of the entity. At operation 915, the LCM 205 if there are additional upgrades to be performed. If yes, the process 850 loops back to the operation 900. Otherwise, the process 850 ends at operation 920.

Thus, an LCM upgrade may include various stages: (1) pre-check stage in which checks for error conditions prior to commencing the upgrade are made; (2) download stage in which artifacts required for the upgrade are downloaded; (3) upgrade stage in which the upgrade operation is performed; and (4) post-actions stage in which additional checks to determine whether the upgrade was successful are performed. The upgrade stage may itself include multiple stages as follows: (1) performing actions to prepare the entity being upgraded for the upgrade (e.g., enter host/CVM into maintenance mode, bring down services, etc.); (2) staging the artifacts onto the upgrade environment; (3) performing one or more upgrade stages as defined in the module metadata, which may be performed either synchronously or asynchronously based on the configuration of the module; (4) cleaning up of the artifacts after the upgrade; and (5) performing complementary actions to bring the system back to steady state (e.g., exit host/CVM maintenance mode, bring back up services, reboot, etc.).

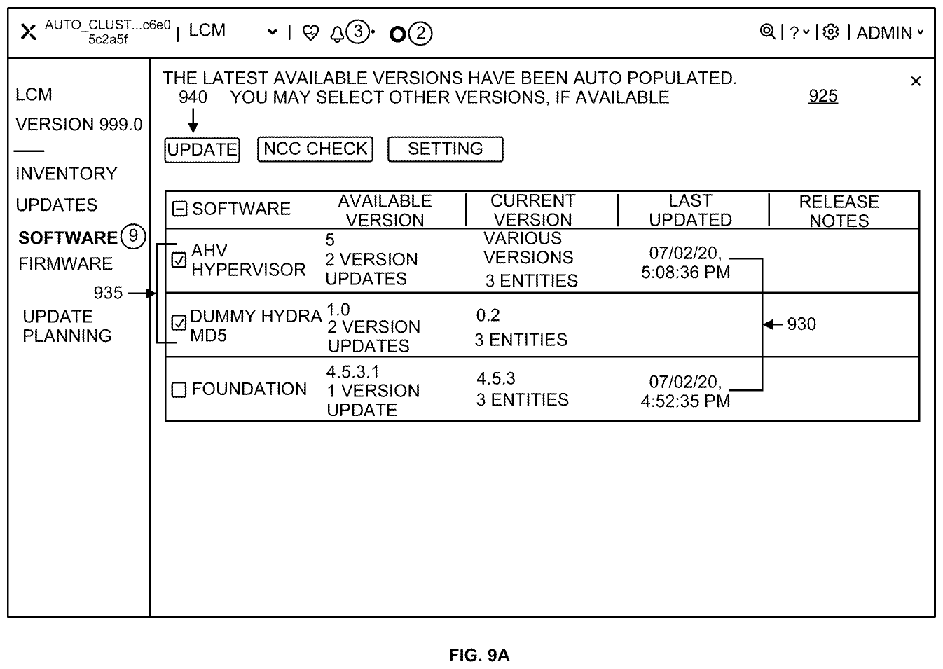

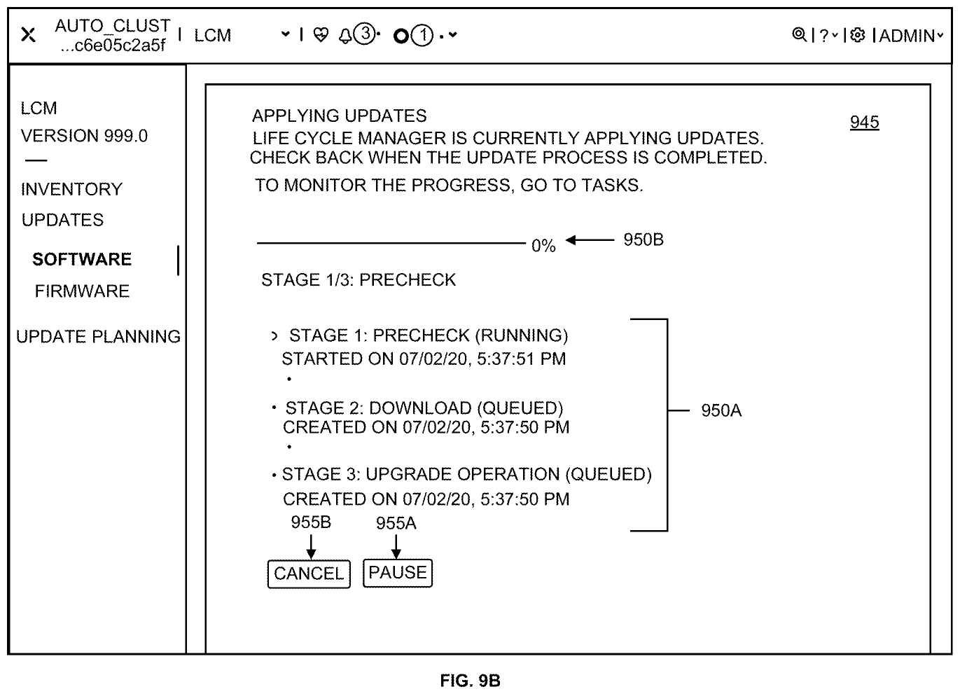

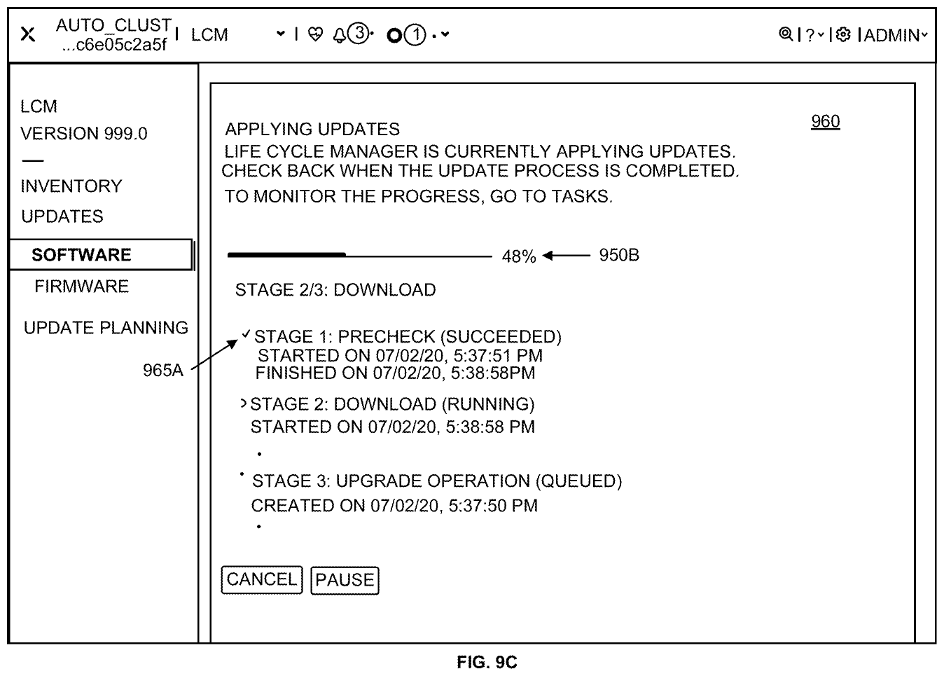

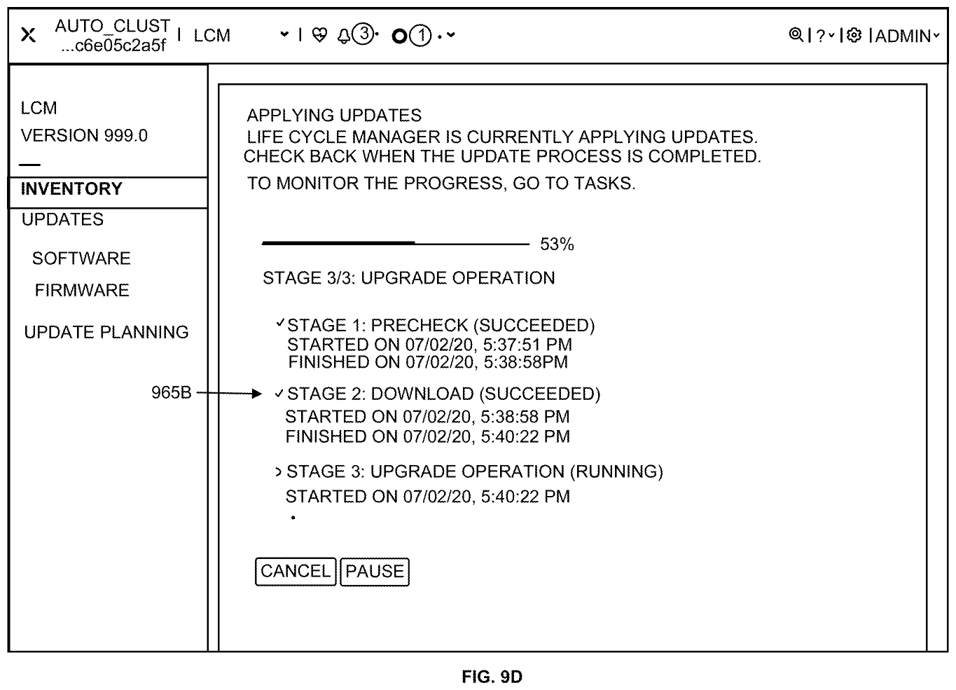

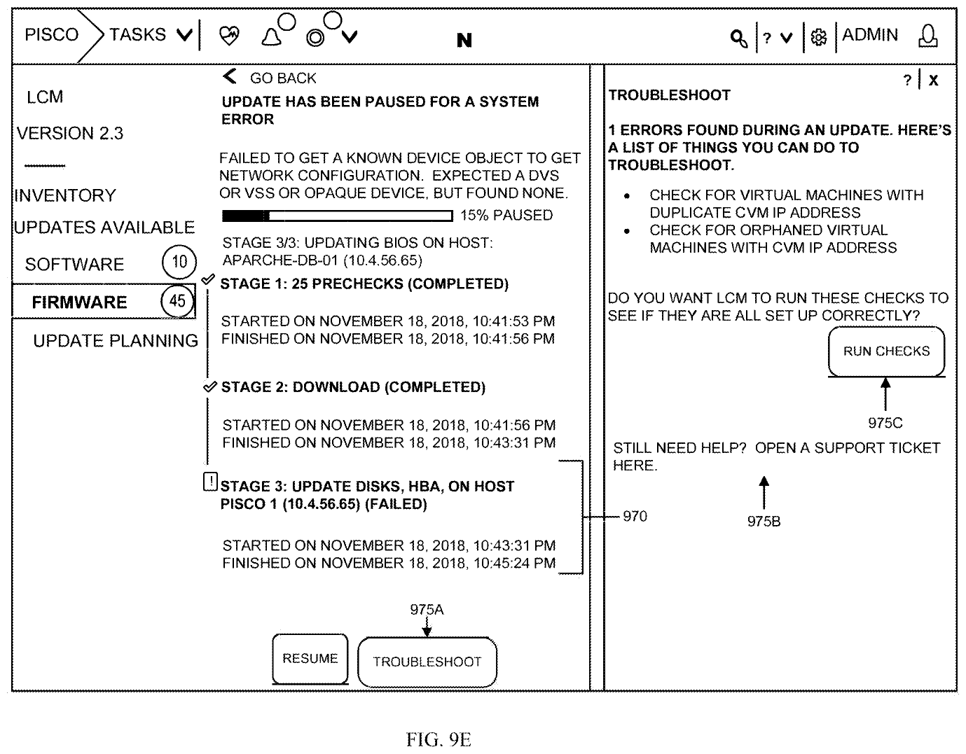

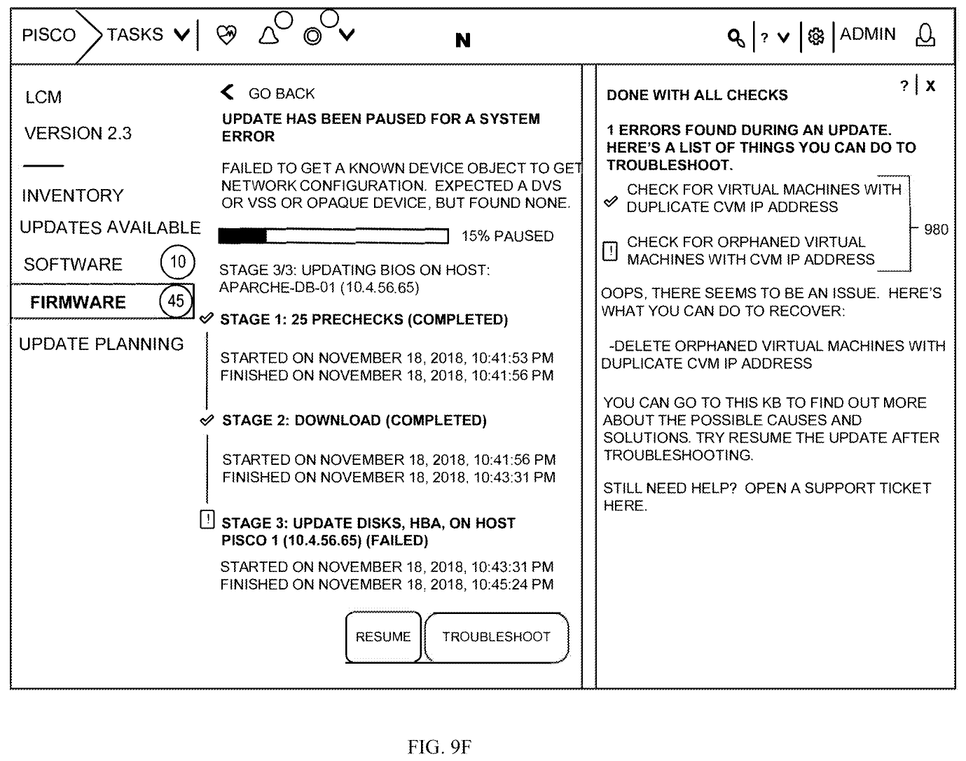

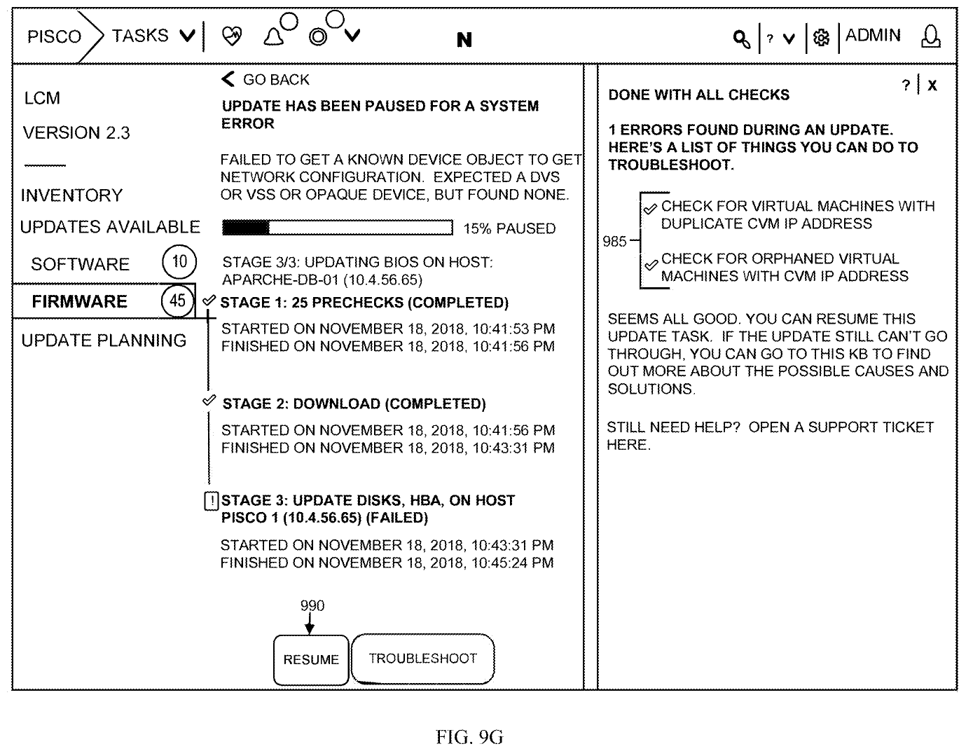

Turning now to FIGS. 9A-9G, example screenshots showing execution assistance feature of the LCM is shown, in accordance with some embodiments of the present disclosure. The execution assistance feature helps in pausing the upgrades on-demand or when recoverable errors are encountered. Upon pausing, the execution assistance feature also recommends recovery actions and resumes the upgrades from where they were left off after the recovery actions are completed. Referring specifically to FIG. 9A, a user interface 925 shows available upgrades 930. The user interface 925 also shows that the user has selected upgrades 935 to be applied to the underlying cluster. The user may then click on an update button 940 to start the update process, which takes the user-to-user interface 945 of FIG. 9B.

The user interface 945 shows that each of the selected upgrades 935 has three stages 950A, including a pre-upgrade stage, a download stage and the actual upgrade stage. The user interface 945 also includes a progress bar 950B to show the progress of the upgrade. The user interface 945 also includes a pause button 955A to pause the upgrade and a cancel button 955B to cancel the upgrade. If the user pauses the upgrade operation by clicking on the pause button 955, when the LCM 205 determines it is safe to pause the upgrade process, the LCM pauses the upgrade. When the upgrade is paused, the pause button 955A converts to a resume button. When the user clicks on the resume button, the upgrade process restarts from where it left off. It is to be understood that clicking on the pause button 955A may not pause the upgrade process if the LCM 205 determines that the upgrade process cannot be safely paused.

In some embodiments, pausing the upgrade during the pre-upgrade stage or the download stage may be considered safe (e.g., may not corrupt the upgrade process). FIG. 9C shows a user interface 960 in which the progress bar 950B has been updated to indicate that a pre-check stage is completed, as indicated by a check mark 965A. FIG. 9D shows that the download stage is also complete as indicated by check mark 965B.

Referring now to FIG. 9E, in some embodiments, a user can configure the LCM 205 to auto-pause when the LCM encounters recoverable errors. For example, as shown in FIG. 9E, upgrade stage 970 is paused due to the LCM 205 encountering recoverable errors. When the LCM 205 auto-pauses the upgrade process, the user may click on a troubleshoot button 975A to open a troubleshooting screen 975B. The troubleshooting 975B identifies the encountered errors. The user may click on a run checks button 975C to start the troubleshooting process. Upon clicking on the run checks button 975C, the LCM 205 identifies fixes 980 as shown in FIG. 9F. FIG. 9G shows that the fixes 980 have been corrected as indicated by checkmarks 985. The user may then click on a resume button 990 to resume the upgrade process.

Thus, the execution assistance feature of the LCM 205 pauses upgrades, diagnoses upgrade issues, recommends recovery actions, and resume upgrades with minimal intervention from the user. Thus, the upgrade assistance of the LCM 205 provides planning assistance, as well as execution assistance.

It is to be understood that any examples used herein are simply for purposes of explanation and are not intended to be limiting in any way. It is also to be understood that any examples used herein are simply for purposes of explanation and are not intended to be limiting in any way.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
receiving, by a life cycle manager in a virtual computing system, a maintenance window from a user during which to upgrade a cluster of the virtual computing system;
determining, by the life cycle manager, available upgrades for the cluster;
presenting, by the life cycle manager, one or more upgrade plans to the user, wherein each of the one or more upgrade plans is created to be completed within the maintenance window and comprises one or more of the available upgrades selected based on a total upgrade time computed for each of the available upgrades;
receiving, by the life cycle manager, selection of one of the one or more upgrade plans from the user; and
upgrading, by the life cycle manager, the cluster based on the one of the one or more upgrade plans that is selected.

2. The method of claim 1, wherein the total upgrade time for a next available upgrade is computed based on metrics collected from the cluster after a previously applied available upgrade on the cluster.

3. The method of claim 1, further comprising training, by the life cycle manager, a learning engine using metrics collected from the cluster for predicting granular times for each stage of an upgrade, wherein the total upgrade time for each of the available upgrades is computed based on the granular times for each stage of the upgrade.

4. The method of claim 3, wherein the granular times comprise at least one of a pre-check time, a module download time, a pre-actions time, an upgrade time, and a post-action time.

5. The method of claim 1, further comprising:
grouping, by the life cycle manager, a plurality of the available upgrades into a batch; and
computing, by the life cycle manager, the total upgrade time for the batch.

6. The method of claim 1, wherein the total upgrade time for a first available upgrade of the available upgrades is computed as a function of a pre-check time, a module download time, a pre-actions time, an upgrade time, and a post-action time.

7. The method of claim 1, wherein the available upgrades that are selected for a particular upgrade plan are further based on a criticality of the available upgrades.

8. The method of claim 1, wherein the available upgrades that are selected for a particular upgrade plan are further based on dependencies of the available upgrades.

9. The method of claim 1, wherein at least one of the one or more upgrade plans comprises an available upgrade that has a longest upgrade time.

10. The method of claim 1, wherein at least one of the one or more upgrade plans comprises a subset of the available upgrades that can be performed on a single entity of the cluster.

11. A non-transitory computer-readable media comprising computer-readable instructions stored thereon that when executed by a processor of a lifecycle manager associated with a virtual computing system cause the processor to perform a process comprising:
receiving a maintenance window from a user during which to upgrade a cluster of the virtual computing system;
determining available upgrades for the cluster;
presenting one or more upgrade plans to the user, wherein each of the one or more upgrade plans is created to be completed within the maintenance window and comprises one or more of the available upgrades selected based on a total upgrade time computed for each of the available upgrades;
receiving selection of one of the one or more upgrade plans from the user; and
upgrading the cluster based on the one of the one or more upgrade plans that is selected.

12. The non-transitory computer-readable media of claim 11, wherein the total upgrade time for a next available upgrade is computed based on metrics collected from the cluster after a previously applied available upgrade on the cluster.

13. The non-transitory computer-readable media of claim 11, wherein the processor executes computer-readable instructions to train a learning engine using metrics collected from the cluster to predict granular times for each stage of an upgrade, wherein the total upgrade time for each of the available upgrades is computed based on the granular times for each stage of the upgrade.

14. The non-transitory computer-readable media of claim 13, wherein the granular times comprise at least one of a pre-check time, a module download time, a pre-actions time, an upgrade time, and a post-action time.

15. The non-transitory computer-readable media of claim 11, wherein the processor executes computer-readable instructions to:
group a plurality of the available upgrades into a batch; and
compute the total upgrade time for the batch.

16. The non-transitory computer-readable media of claim 11, wherein the total upgrade time for a first available upgrade of the available upgrades is computed as a function of a pre-check time, a module download time, a pre-actions time, an upgrade time, and a post-action time.

17. The non-transitory computer-readable media of claim 11, wherein the available upgrades that are selected for a particular upgrade plan are further based on a criticality of the available upgrades.

18. The non-transitory computer-readable media of claim 11, wherein the available upgrades that are selected for a particular upgrade plan are further based on dependencies of the available upgrades.

19. The non-transitory computer-readable media of claim 11, wherein at least one of the one or more upgrade plans comprises an available upgrade that has a longest upgrade time.

20. The non-transitory computer-readable media of claim 11, wherein at least one of the one or more upgrade plans comprises a subset of the available upgrades that can be performed on a single entity of the cluster.

21. A system comprising:
a memory of a lifecycle manager in a virtual computing system, the memory storing computer-readable instructions; and
a processor executing the computer-readable instructions to:
receive a maintenance window from a user during which to upgrade a cluster of the virtual computing system;
determine available upgrades for the cluster;
present one or more upgrade plans to the user, wherein each of the one or more upgrade plans is created to be completed within the maintenance window and comprises one or more of the available upgrades selected based on a total upgrade time computed for each of the available upgrades;
receive selection of one of the one or more upgrade plans from the user; and
upgrade the cluster based on the one of the one or more upgrade plans that is selected.

22. The system of claim 21, wherein the total upgrade time for a next available upgrade is computed based on metrics collected from the cluster after a previously applied available upgrade on the cluster.

23. The system of claim 21, wherein the processor executes computer-readable instructions to train a learning engine using metrics collected from the cluster to predict granular times for each stage of an upgrade, wherein the total upgrade time for each of the available upgrades is computed based on the granular times for each stage of the upgrade.

24. The system of claim 23, wherein the granular times comprise at least one of a pre-check time, a module download time, a pre-actions time, an upgrade time, and a post-action time.

25. The system of claim 21, wherein the processor executes computer-readable instructions to:
group a plurality of the available upgrades into a batch; and
compute the total upgrade time for the batch.

26. The system of claim 21, wherein the total upgrade time for a first available upgrade of the available upgrades is computed as a function of a pre-check time, a module download time, a pre-actions time, an upgrade time, and a post-action time.

27. The system of claim 21, wherein the available upgrades that are selected for a particular upgrade plan are further based on a criticality of the available upgrades.

28. The system of claim 21, wherein the available upgrades that are selected for a particular upgrade plan are further based on dependencies of the available upgrades.

29. The system of claim 21, wherein at least one of the one or more upgrade plans comprises an available upgrade that has a longest upgrade time.

30. The system of claim 21, wherein at least one of the one or more upgrade plans comprises a subset of the available upgrades that can be performed on a single entity of the cluster.
